(19) United States
(12) Patent Application Publication
(10) Pub. No.: US 2012/0214147 A1
(43) Pub. Date: Aug. 23, 2012

(54) System and Method for Adaptive Knowledge Assessment And Learning

(75) Inventors: Steve Ernst, Superior, CO (US); Charles J. Smith, Encinitas, CA (US); Gregory Klinkel, Boulder, CO (US); Robert Burgin, Boulder, CO (US)

(73) Assignee: Knowledge Factor, Inc., Boulder, CO (US)

(21) Appl. No.: 13/216,017

(22) Filed: Aug. 23, 2011

Related U.S. Application Data
(63) Continuation-in-part of application No. 13/029,045, filed on Feb. 16, 2011.

(51) Int. Cl. G09B 7/00

(52) U.S. Cl. 434/353

(57) ABSTRACT

A services-oriented system structure for knowledge assessment and learning comprises a display device for displaying to a learner at a client terminal a plurality of multiple-choice questions and two-dimensional answers, an administration server adapted to administer one or more users of the system, a content management system server adapted to provide an interface for the one or more users to create and maintain a library of learning resources, a learning system server comprising a database of learning materials, wherein the plurality of multiple-choice questions and two-dimensional answers are stored in the database for selected delivery to the client terminal, and a registration and data analytics server adapted to create and maintain registration information about the learners.

### PRIORITY AND RELATED APPLICATIONS

This application is a Continuation-in-Part of U.S. patent application Ser. No. 13/029,045 filed on Feb. 16, 2011. This Application is related to U.S. patent application Ser. No. 12/908,303, filed on Oct. 20, 2010, U.S. patent application Ser. No. 10/398,625, filed on Sep. 23, 2003, U.S. patent application Ser. No. 11/187,606, filed on Jul. 23, 2005, and U.S. Pat. No. 6,921,268, issued on Jul. 26, 2005. The details of each of the above listed applications are hereby incorporated by reference into the present application by reference and for all proper purposes.

### FIELD OF THE INVENTION

Aspects of the present invention relate to knowledge assessment and learning and to microprocessor and networked based testing and learning systems. Aspects of the present invention also relate to knowledge testing and learning methods, and more particularly, to methods and systems for Confidence-Based Assessment (“CBA”) and Confidence-Based Learning (“CBL”), in which a single answer from a learner generates two metrics with regard to the individual's confidence and correctness in his or her response.

### BACKGROUND

Traditional multiple-choice testing techniques to assess the extent of a person's knowledge in a subject matter include varying numbers of possible choices that are selectable by one-dimensional or right/wrong (RW) answers. A typical multiple-choice test might include questions with three possible answers, where generally one of such answers can be eliminated by the learner as incorrect as a matter of first impression. This gives rise to a significant probability that a guess on the remaining answers could result in a response marked as correct that may or may not be correct. Under this situation, a successful guess would mask the true extent or the state of knowledge of the learner, as to whether he or she is informed (i.e., confident with a correct response), misinformed (i.e., confident in the response, which response, however, is not correct) or lacked information (i.e., the learner explicitly states that he or she does not know the correct answer, and is not allowed to respond in that fashion). Accordingly, the traditional multiple-choice one-dimensional testing technique is highly ineffectual as a means to measure the true extent of knowledge of the learner. Despite this significant drawback, the traditional one-dimensional, multiple-choice testing techniques are widely used by information-intensive and information-dependent organizations such as banking, insurance, utility companies, educational institutions and governmental agencies.

Traditional multiple-choice, one-dimensional (right/wrong), testing techniques are forced-choice tests. This format requires individuals to choose one answer, whether they know the correct answer or not. If there are three possible answers, random choice will result in a 33% chance of scoring a correct answer. One-dimensional scoring algorithms usually reward guessing. Typically, wrong answers are scored as zero points, so that there is no difference in scoring between not answering at all and taking an unsuccessful guess. Since guessing sometimes results in correct answers, it is always better to guess than not to guess. It is known that a small number of traditional testing methods provide a negative score for wrong answers, but usually the algorithm is designed such that eliminating at least one answer shifts the odds in favor of guessing. So for all practical purposes, guessing is still rewarded.

In addition, prior one-dimensional testing techniques encourage individuals to become skilled at eliminating possible wrong answers and making best-guess determinations at correct answers. If individuals can eliminate one possible answer as incorrect, the odds of picking a correct answer reach 50%. In the case where 70% is passing, individuals with good guessing skills are only 20% away from passing grades, even if they know almost nothing. Thus, the one-dimensional testing format and its scoring algorithm shift the purpose of individuals, their motivation, away from self-assessment and receiving accurate feedback, and toward inflating test scores to pass a threshold.

### SUMMARY OF THE INVENTION

Aspects of the present invention provide a method and system for knowledge assessment and learning that accurately assesses the true extent of a learner's knowledge, and provides learning or educational materials remedially to the subject according to identified areas of deficiency. The invention incorporates the use of Confidence Based Assessments and Learning techniques and is deployable on a microprocessor based computing device or networked communication client-server system.

Other aspects of devices and methods in accordance with the present invention provide a mechanism for personalized, adaptive assessment and learning where the content of the learning and assessment system is delivered to every learner in a personalized manner depending upon how each learner responds to the particular questions. In certain embodiments, these responses will vary depending on the knowledge, skill and confidence manifest by each learner, and the system and its underlying algorithms will adaptively feed future assessment questions and associated remediation depending on the knowledge quality provided by the learner for each question.

Another aspect of the invention is the use of a reusable learning object structure that provides a built-in mechanism to seamlessly integrate detailed learning outcome statements, subject matter that enables the learner to acquire the necessary knowledge and/or skills relative to each learning outcome statement, and a multi-dimensional assessment to validate whether the learner has actually acquired the knowledge and/or skills relative to each learning outcome statement along with his/her confidence in that knowledge or skills. The reusability of those learning objects is enabled through the content management system built into the invention such that authors can easily search for, identify, and re-use or re-purpose existing learning objects.

Other aspects of the invention encompasses an integrated reporting capability so that administrators, authors, registrars and analysts can evaluate both the quality of the knowledge manifest by each learner, and the quality of the learning materials as displayed in the learning objects. The reporting capability is highly customizable based on data stored in the database for each user response.

In accordance with another aspect, a services-oriented system structure for knowledge assessment and learning comprises a display device for displaying to a learner at a client terminal a plurality of multiple-choice questions and two-dimensional answers, an administration server adapted to administer one or more users of the system, a content management system server adapted to provide an interface for the one or more users to create and maintain a library of learning resources, a learning system server comprising a database of learning materials, wherein the plurality of multiple-choice questions and two-dimensional answers are stored in the database for selected delivery to the client terminal, and a registration and data analytics server adapted to create and maintain registration information about the learners. In one embodiment the system for knowledge assessment performs a method of transmitting to the display device the plurality of multiple-choice questions and two-dimensional answers thereto, the answers including a plurality of full-confidence answers consisting of single-choice answers, a plurality of partial-confidence answers consisting of one or more sets of multiple single-choice answers, and an unsure answer, administering an assessment by presenting to the learner via the display device the plurality of multiple-choice questions and the two-dimensional answers thereto, and receiving via the display device the learner's selected answer to the multiple-choice questions by which the learner indicates both their substantive answer and the level of confidence category of their answer, and scoring the assessment by assigning a knowledge state designation to at least one of the answers by the learner.

The methods underlying the system have been purposely created such that the methods leverage key findings and applications of research related to learning and memory, with the intention of significantly increasing the efficiency and effectiveness of the learning process. Those methods are encapsulated in the various embodiments of the system.

### BRIEF DESCRIPTION OF THE DRAWINGS

FIG. 1 is a system level architecture diagram showing the interconnection and interaction of various aspects of a learning system constructed in accordance with aspects of the present invention.

FIG. 2 is a system level and data architecture diagram showing the interconnection and interaction of various aspects of a learning system constructed in accordance with aspects of the present invention.

FIG. 3 is another system level and data architecture diagram in accordance with aspects of the present invention.

FIG. 4 is another system level and date architecture diagram in accordance with aspects of the present invention.

FIGS. 5 and 6 are embodiments of a learning system data gathering and user interface used in connection with aspects of the present invention.

FIG. 7A-7C illustrate a round selection algorithm used in accordance with aspects of the present invention.

FIGS. 8A-8D illustrate examples of process algorithms used in accordance with aspects of the present invention that outline how user responses are scored, and how those scores determine the progression through the assessments and remediation.

FIGS. 9-17 illustrate various user interface and reporting structures used in connection with aspects of the present invention.

FIG. 18 illustrates the structure of reusable learning objects, how those learning objects are organized into modules, and how those modules are published for display to learners.

FIG. 19 illustrates a machine or other structural embodiment that may be used in conjunction with aspects of the present invention.

### DETAILED DESCRIPTION

Aspects of the present invention build upon the Confidence-Based Assessment (“CBA”) and Confidence-Based Learning (“CBL”) Systems and methods disclosed in U.S. patent application Ser. No. 13/029,045, U.S. patent application Ser. No. 12/908,303, U.S. patent application Ser. No. 10/398,625, U.S. patent application Ser. No. 11/187,606, and U.S. Pat. No. 6,921,268, all of which are incorporated into the present application by reference and all of which are owned by Knowledge Factor, Inc. of Boulder Colo.

The present description focuses on embodiments of the system pertaining to the system architecture, user interface, algorithm, and other modifications. At times other embodiments of the system are described to highlight specific similarities or differences, but those descriptions are not meant to be inclusive of all embodiments of the system as described in related prior patents and patent applications owned by Knowledge Factor.

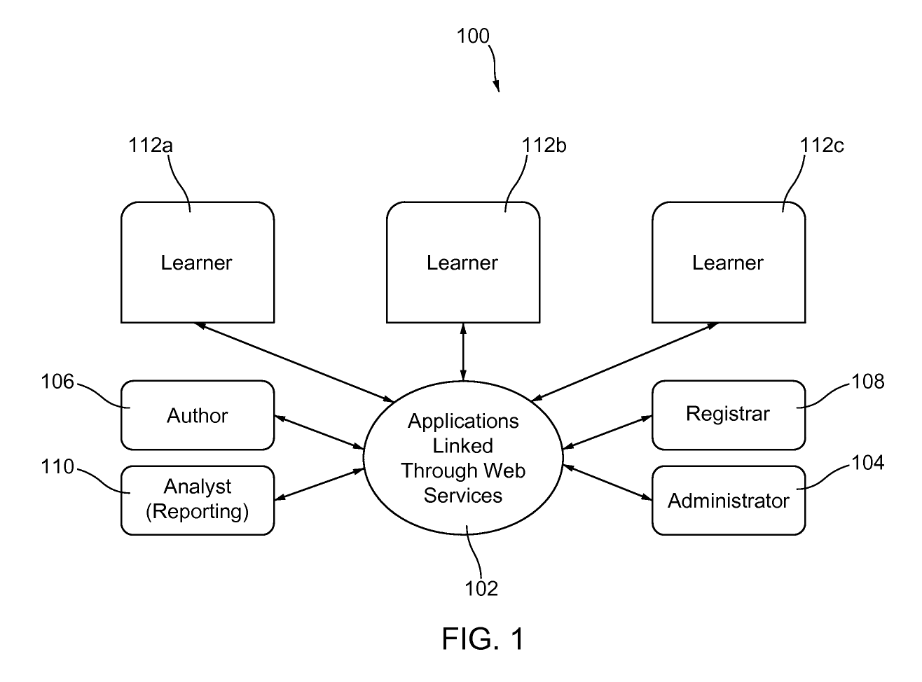

As shown in FIG. 1, a knowledge assessment method and learning system 100, manifest as a group of applications 102 that interoperate through web services, provides a distributed assessment and learning solution to serve the interactive needs of its users. The primary roles in the system are as follows:
a. Administrator 104: Administers the system at large, and has access to all the applications that make up the system, and which interoperate through web services.
b. Author 106: Develops, manages and publishes learning and assessment content.
c. Registrar 108: Manages learner registration, including creating new learner accounts and managing learner assignments.
d. Analyst 110: Manages reporting for one or more business units.
e. Learner(s) 112a-112c: The ultimate end-user of the system at large, and who accesses learning and assessment modules delivered by the system.

Any number of users may perform one function or fill one role only, while a single user may perform several functions or fill many roles. For example, an administrator 104 may also serve as a registrar 108 or analyst 110 (or other roles), or an author 106 may also serve as an analyst 110.

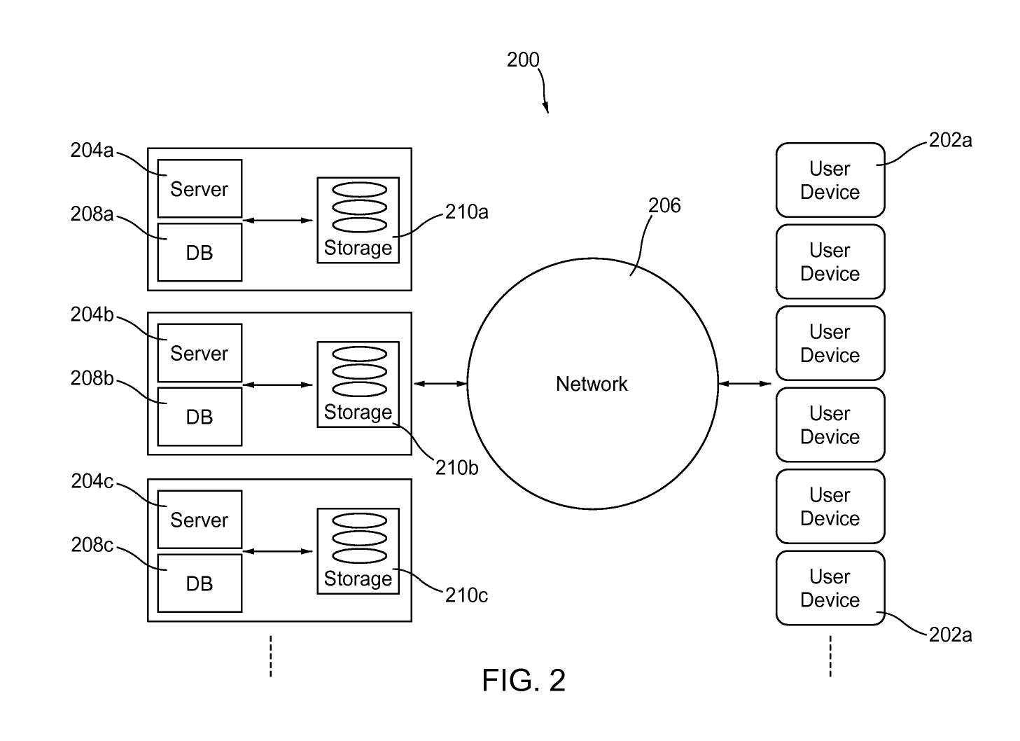

FIG. 2 shows one embodiment of a computer network architecture 200 that may be used to effect the network-based distribution of the knowledge assessment and learning functions in accordance with aspects of the present invention. CB learning content is delivered to the learners of each registered organization or individually through a plurality of devices 202a-202n, such as computers, tablets, smart phones, or other devices as known in the art that are remotely located for convenient access by the learners, administrators and other roles. Each access device preferably employs sufficient processing power to deliver a mix of audio, video, graphics, virtual reality, documents, and data.

Groups of learner devices and administrator devices are connected to one or more network servers 204a-204c via the Internet or other network 206. Servers and associated software 208a-208c (including databases) are equipped with storage facilities 210a-210c to serve as a repository for user records and results. Information is transferred via the Internet using industry standards such as the Transmission Control Protocol/Internet Protocol (“TCP/IP”).

In one embodiment, the system 200 conforms to an industry standard distributed learning model. Integration protocols, such as Aviation Industry CBT Committee (AICC), Learning Tools Interoperability (LTI), and customized web services, are used for sharing courseware objects across systems.

Embodiments and aspects of the present invention provide a method and system for conducting knowledge assessment and learning. Various embodiments incorporate the use of confidence based assessment and learning techniques deployable on a micro-processor-based or networked communication client-server system, which gathers and uses knowledge-based and confidence-based information from a learner to create adaptive, personalized learning plans for each learner. In a general sense the assessments incorporate non-one-dimensional testing techniques.

In accordance with another aspect, the present invention comprises a robust method and system for Confidence-Based Assessment (“CBA”) and Confidence-Based Learning (“CBL”), in which one answer generates two metrics with regard to the individual's confidence and correctness in his or her response to facilitate an approach for immediate remediation. This is accomplished through various tools including, but not limited to:

1. An assessment and scoring format that eliminates the need to guess at answers. This results in a more accurate evaluation of “actual” information quality.

2. A scoring method that more accurately reveals what a person: (1) accurately knows; (2) partially knows; (3) doesn't know; and (4) is sure that they know, but is actually incorrect.

3. An adaptive and personalized knowledge profile that focuses only on those areas that truly require instructional or reeducation attention. This eliminates wasted time and effort training in areas where attention really isn't required.

In learning modules, the foregoing methods and tools are implemented by the a method or “learning cycle” such as the following:

1. The learner is asked to complete a formative assessment. This begins with the step of compiling a standard three to five answer multiple-choice test into a structured CBA format with possible answers for each question that cover three states of mind: confidence, doubt, and ignorance, thereby more closely matching the state of mind of the learner.

2. Review the personalized knowledge profile, which is a summary of the learner's responses to the initial assessment relative to the correct responses. The Confidence Based (CB) scoring algorithm is implemented in such a way that it teaches the learner that guessing is penalized, and that it is better to admit doubts and ignorance than to feign confidence. The CB set of answers are then compiled and displayed as a personalized knowledge profile to more precisely segment answers into meaningful regions of knowledge, giving individuals and organizations rich feedback as to the areas and degrees of mistakes (misinformation), unknowns, doubts and mastery. The personalized knowledge profile is a much better metric of performance and competence. For example, in the context of the corporate training environment, the individualized learning environment encourages better-informed employees that retain higher information quality and, thereby reduce costly knowledge and information errors, and increase productivity.

3. Review the question, response, correct answer, and explanation in regard to the learning material. Ideally, explanations for both correct and incorrect answers are provided (at the discretion of the author).

4. Review the Additional Learning (in some embodiments described as “Expand Your Knowledge”) learning materials to gain a more detailed understanding of the subject matter (breadth and depth).

5. Iteration—The process can be repeated as many times as required by the individual learner in order to demonstrate an appropriate understanding of, and confidence in, the subject matter. In some embodiments, and as part of this iterative model, answers scored as confident and correct (depending on which algorithm is used) can be removed from the list of questions presented to the learner so that the learner can focus on his/her specific skill gap(s). During each iteration, the number of questions presented to the learner can be represented by a subset of all questions in a module; this is configurable by the author of the module. In addition, the questions, and the answers to each question, are presented in random order during each iteration through the use of a random number generator invoked within the software code that makes up the system.

In accordance with one aspect, the invention produces a personalized knowledge profile, which includes a formative and summative evaluation for the learner and identifies various knowledge quality levels. Based on such information, the system correlates, through one or more algorithms, the user's knowledge profile to a database of learning materials, which is then communicated to the system user or learner for review and/or reeducation of the substantive response.

Aspects of the present invention are adaptable for deployment on a stand-alone personal computer system. In addition, they are also deployable on a computer network environment such as the World Wide Web, or an intranet or mobile network client-server system, in which, the “client” is generally represented by a computing device adapted to access the shared network resources provided by another computing device, the server. See for example the network environments described in conjunction with FIG. 2. Various database structures and data application layers are incorporated to enable interaction by various user permission levels, each of which is described more fully herein.

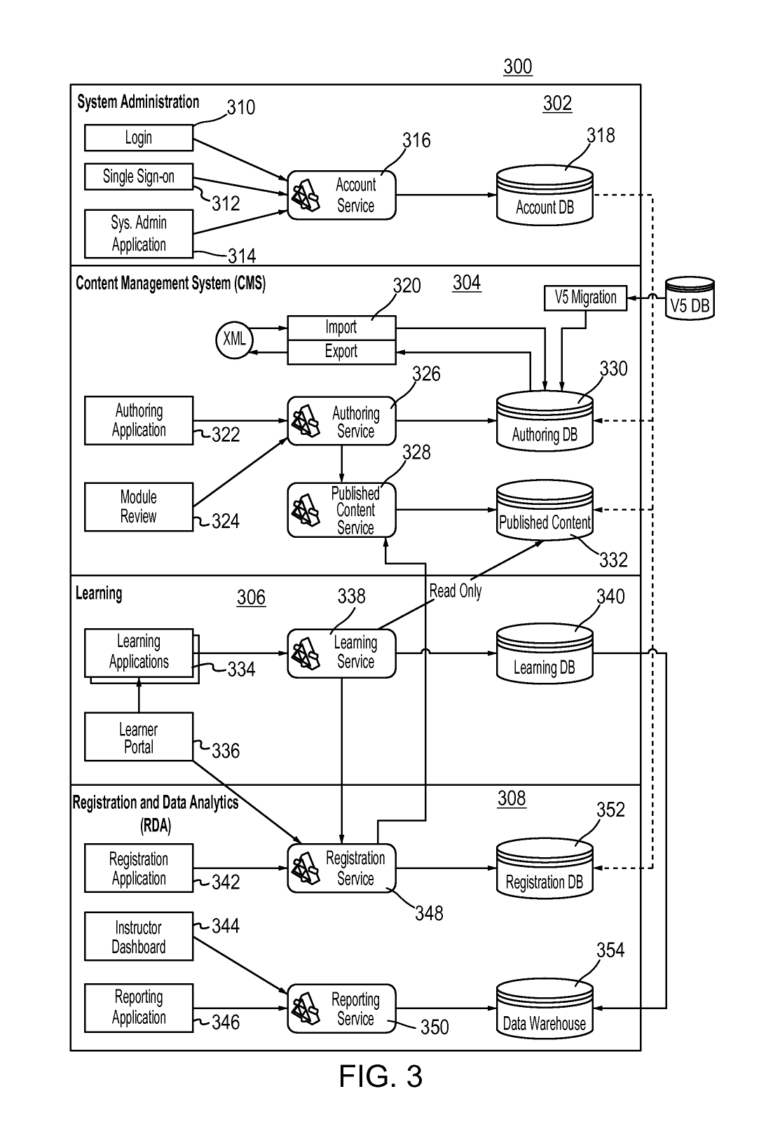

With reference to FIG. 3, another embodiment of a system 300 constructed in accordance with aspects of the present invention, comprises one or more of the following applications, where each application is separate but interoperable as a whole through web services:
a. System Administration 302: This application is used to administer all aspects of the system at large, which is managed by the Administrator role.
b. Content Management System (or Authoring) 304: This application is used for all content authoring, as well as for publishing and retiring all content, and for managing all content in the system. These functions are managed by the Author and Content Manager roles.
c. Learning 306: This application is used for all learning and/or assessment, and is where learners will log in to the system.
d. Registration and Data Analytics (RDA) application 308: This application is used to manage learner registration, which is managed by the Registrar role, as well as all reporting, which is managed by the Analyst role. In addition, other roles, such as the Instructor role, can log in here to view reports designed specifically for that role.

The various tasks of the knowledge assessment and learning system are supported by web services-based network architecture and software solution. FIG. 3 shows the individual integrated applications that make up the system 300—Administration 302, Content Management System (Authoring) 304, Learning (which also includes Assessment) 306, and Registration and Data Analytics 308.

The System Administration module 302 includes such components as a login function 310, single sign-on function 312, a system administration application 314, an account service module 316 and an account database structure 318. The System Administration module 302 functions to administer the various customer accounts present in the application.

The CMS module 304 includes an authoring application 322 that provides content authoring functionality to author and structure the learning elements and curriculum, a module review function 324, an import/export function 320 that allows for xml or another form-based data import, an authoring service 326, a published content service 328, an authoring database 330 and a published content database 332. The CMS module 304 allows for curriculum functionality to manage the various elements that make up the curriculum and publishing functionality to formally publish the learning content so that it is available to end-users.

The Learning module 306 includes a learner portal 336, a learning applications function 334 and a learning service function 338. Also included is a learning database 340. Learning and assessment functionality leverages various of the other aspects and features described herein.

The Registration and Data Analytics (RDA) 308 includes a registration application 342, an instructor dashboard 344 and a reporting application 346, a registration service 348, a reporting service 350, a registration database 352 and a data warehouse database 354. The Registration and Data Analytics 308 includes functionality to administer registration of the various end-user types in the particular application and functionality to display relevant reports to end-users in a context dependent manner based on the role of the user.

In operation, any remotely located user may communicate via a device with the system (e.g. FIG. 2 or 3). Aspects of the system and its software provide a number of web-based pages and forms, as part of the communication interface between a user and the system to enable quick and easy navigation through the functions relevant to each role. For example, a web-based, browser-supported display of the learning application is presented to the learner, which serves as a gateway for a user to access the system's Web site and its related contents. The learner may access the system directly through the learning application, or through an organization's Learning Management System (LMS) that is integrated with the system through industry standard protocols (e.g., AICC, LTI, web services).

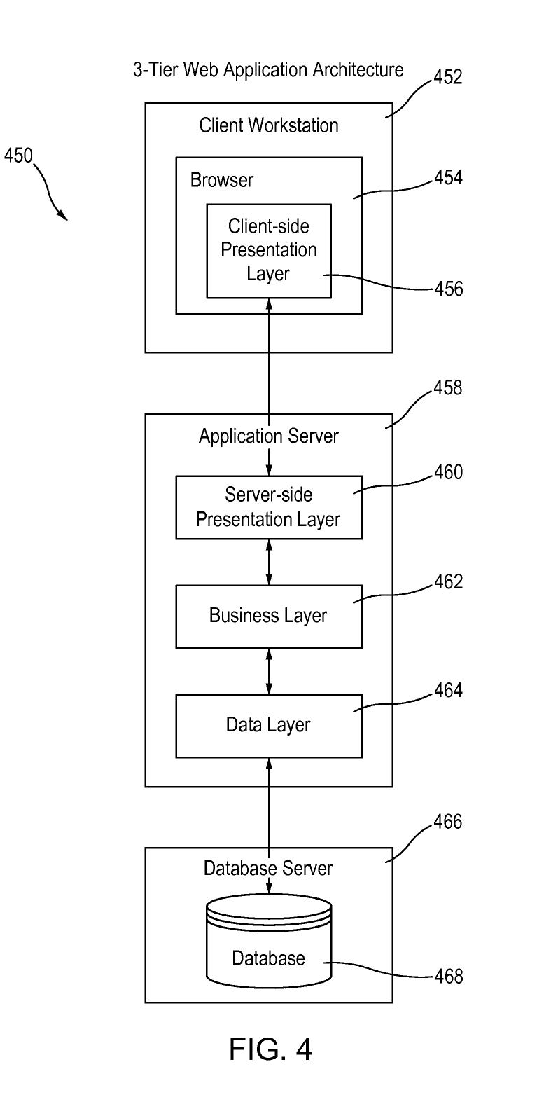

FIG. 4 illustrates a system architecture diagram 450 that may be implemented in accordance with one aspect of the present invention. The web application architecture 450 is one structural embodiment that may serve to implement the various machine oriented aspects of devices and system constructed in accordance with the present invention. The architecture 450 consists of three general layers, a presentation layer, a business logic layer and a data abstraction and persistence layer. As shown in FIG. 4, a client workstation 452 runs a browser 454 or other user interface application that itself includes a client-side presentation layer 456. The client workstation 452 is connected to an application server 458 that includes a server-side presentation layer 460, a business layer 462 and a data layer 464. The application server 458 is connected to a database server 466 including a database 468.

Each application includes a user login capability, incorporating necessary security processes for system access and user authentication. The login process prompts the system to effect authentication of the user's identity and authorized access level, as is generally done in the art.

Referring again to FIG. 3, the authoring application 322 allows the author role, such as a content developer or an instructional designer, to construct learning objects, associated learning or assessment modules, and curricula. Login to the authoring application 322 leads to an authoring (content development) screen. The authoring main screen incorporates navigational buttons or other means to access the major aspects of learning and assessment content. The authoring screen includes several software capabilities in support of functions such as (in part) creating, editing and uploading learning objects, review of reviewers' feedback, creating or managing learning and/or assessment modules, and publishing or retiring modules. For purposes of discussion herein the authoring application is also referred to as the “Content Management System” or “CMS.”

Authoring further provides editorial and formatting support facilities in a What You See Is What You Get (WYSIWYG) editing window that creates Hypertext Mark-Up Language (“HTML”) and other browser/software language for display by the system to various user types. In addition, authoring provides hyperlink support and the ability to include and manage multiple media types common to web-based applications.

Authoring is adapted to also allow the user to upload a text-formatted file, such as xml or csv, for use in importing an entire block of content or portion thereof using bulk upload functionality. In addition, authoring is also adapted to receive and utilize media files in various commonly used formats such as *.GIF, *JPEG, *.MPG, *.FLV and *.PDF (this is a partial list of supported file types). This feature is advantageous in the case where learning or assessment requires an audio, visual and/or multi-media cue.

The authoring application 322 allows authors to use existing learning materials or create new learning materials in the appropriate format. Authoring is accomplished by creating learning objects in the authoring application, or uploading new learning objects through the bulk upload feature, and then combining selected learning objects into learning or assessment modules. Learning objects in the system are comprised of the following:
a. Introduction
b. Question
c. Answers (one correct answer; two to four distractors)
d. Explanation(s)
e. Additional Learning: Additional explanatory material and opportunities for deeper or tangential learning
f. Metadata/Classifications: Data that can be used to assist in searches of learning objects and in reporting; this metadata can be hierarchical or categorical

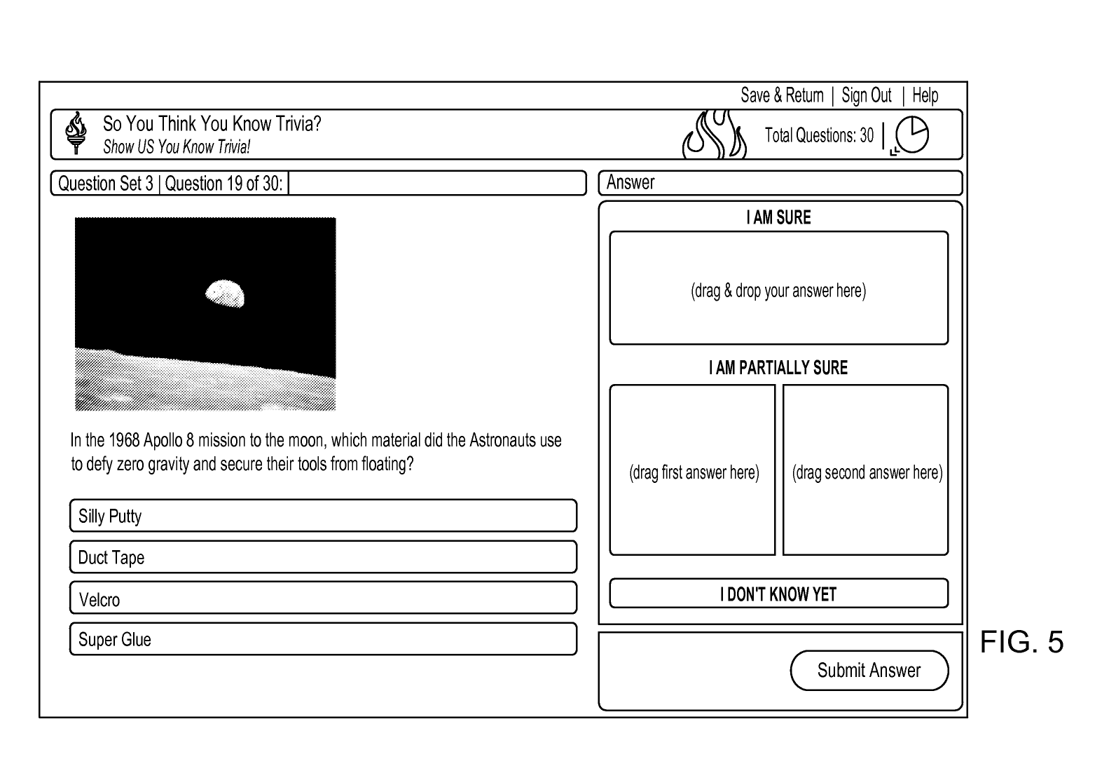

Each question must have a designated answer as the correct choice, and the other two to four answers are identified as being incorrect or misinformed responses, and which are generally constructed as plausible distractors or commonly held misinformation. In the learning example as shown in FIG. 5, the query has four possible answer choices.

Learning objects are organized into modules, and it is these modules that are assigned to learners. The learning objects within each module are then displayed to the learner based on the scoring and display algorithm in the learning application.

Once a learning or assessment module has been created using the authoring application, the module is published in preparation for presentation to learners via the learning application. The learning application then configures the one-dimensional right-wrong answers into the non-one dimensional answer format. Thus, in one embodiment of the present invention in which a query has multiple possible answers, a non-one-dimensional test, in the form of a two-dimensional response, is configured according to predefined confidence categories or levels.

Three levels of confidence categories are provided to the learner, which are designated as: 100% sure (learner selects only one answer and categorizes that response as “I Am Sure”; see e.g. FIG. 5); partially sure (learner selects either one or a pair of choices that best represents the answer and categorizes those responses as “I Am Partially Sure”); and Unknown (categorized by selecting “I Don't Know Yet”). The queries, confidence categories and the associated choices of possible answers are then organized and formatted in a manner that is adaptable for display on the learner's device. Each possible choice of an answer is further associated with input means such as a point-and-click button and/or drag and drop to accept an input from the learner as an indication of a response to his or her selection of an answer. In one embodiment, the presentation of the test queries, confidence categories and answers are supported by commonly used Internet-based browsers. The input means can be shown as separate point-and-click buttons or fields associated with each possible choice of answer, and the learner can either drag-and-drop the answer into the appropriate response category, or can single-click the answer to populate a specific response category.

As seen from the above discussion, the system substantially facilitates the construction of non-one-dimensional queries or the conversion of traditional one-dimensional queries into multi-dimensional queries. The authoring functions of the present invention are “blind” to the nature of the materials from which the learning objects are constructed. For each learning object, the system acts upon the form of the test query and the answer choice selected by the learner. The algorithms built into the system control the type of feedback that is provided to the learner, and also control the display of subsequent learning materials that are provided to the learner based on learner responses to previous queries.

The CMS allows an author to associate each query with specific learning materials or information pertaining to that query in the form of explanations or Additional Learning. The learning materials are stored by the system, providing ready access for use in existing or new learning objects. These learning materials include text, animations, images, audio, video, web pages, and similar sources of training materials. These content elements (e.g., images, audio, video, PDF documents, etc.) can be stored in the system, or on separate systems and be associated with the learning objects using standard HTML and web services protocols.

The system enables the training organization to deliver learning and/or assessment modules. The same learning objects can be used in both (or either) learning and assessment modules. Assessment modules utilize the following elements of the learning objects in the system:
a. Introduction
b. Question
c. Answers (one correct answer; two to four distractors)
d. Metadata: Data that can be used to assist in searches of learning objects and in reporting; this metadata can be hierarchical or categorical

Each learning module is displayed to the learner as two separate, repeated segments. First, the learner is presented with a formative assessment that is used to identify relevant knowledge and confidence gaps manifest by the learner. After the learner completes the formative assessment, then the learner is given an opportunity to fill knowledge gaps through review of explanations and Additional Learning information. The learner continues to be presented with rounds of formative assessment and then review until he/she has demonstrated mastery (confident and correct responses) for the required percentage of learning objects in the module.

The author (and other roles related to curriculum management that will be presented later in this document) can set the following scoring options in learning modules:
a. The number of learning objects in the module that will be presented to the learner in every round of learning as described above (range of one learning object to all learning objects in the module); this setting determines how many learning objects are present in a Question Set.
b. The number of times that a learner must respond confident and correct in consecutive order to a learning object before it is considered mastered (and therefore is no longer displayed in that module)—either once (1× Correct) or twice (2× Correct).
c. The percentage of learning objects in a module that must be mastered (confident and correct) before the module as a whole is considered to be complete (any range between 1% and 100%).
d. Whether images in the introduction will be displayed during the formative assessment portion of each question set once a learner has provided a confident and correct response for a particular learning object; this option is pertinent only to the 2× Correct scoring setting.

In each round of learning, the learning objects are presented to the learner in random order (or in a pre-defined order as set by the Author), and the potential answers to each question are also presented in random order each time that the question is presented to the learner. Which learning objects are displayed in each round (or question set) is dependent on (a) the scoring options listed above, and (b) the algorithms built into the Learning application. The algorithms are described in more detail later in this document. Assessment modules are structured such that all learning objects in the module are presented in a single round.

In accordance with one embodiment, the author (and other roles related to curriculum management that will be presented later in this document) can set the following scoring options in assessment modules: Whether questions in the assessment module will be presented to the learner in random order or in an order defined by the author.

Presentation of the learning and assessment modules to the learner is initiated by first publishing the desired modules from within the authoring application (or CMS). Once the modules are published in the CMS, the learning application is then able to access the modules. Learners then must be registered for the modules in the Registration and Data Analytics application that is part of the system, or in Learning Management Systems or portals operated by customers and which have been integrated with the system.

As an example of one embodiment, the queries or questions would consist of three answer choices and a two-dimensional answering pattern that includes the learner's response and his or her confidence category in that choice. The confidence categories are: “I am sure,” “I am partially sure,” and “I don't know yet.” Another embodiment of the system allows an author to configure the system such that a query without any response is deemed as, and defaults to, the “I don't know yet” choice. In other embodiments, the “I don't know yet” choice is replaced with an “I am not sure” or “I don't know” choice. In other embodiments, up to five answer choices may be provided to the learner.

Learning and/or assessment modules can be administered to separate learners at different geographical locations and at different time periods. In one embodiment of the system, relevant components of the learning objects associated with the learning and/or assessment modules are presented in real-time, and in accordance with the algorithm, between the server and a learner's device, and progress is communicated to the learner as he/she proceeds through the module. In another embodiment of the system, the learning and/or assessment modules can be downloaded in bulk to a learner's device, where the queries are answered in their entirety, explanations and Additional Learning can be reviewed, and real-time progress is provided to the learner, before the responses are communicated (uploaded) to the system.

The system captures numerous time measurements associated with learning or assessment. For example, the system measures the amount of time that was required for the subject to respond to any or all of the test queries presented. The system also tracks how much time was required to review explanation materials and Additional Learning information. When so adapted, the time measuring script or subroutine functions as a time marker. In some embodiments of the present invention, the electronics time marker also identifies the time for the transmission of the test query by the courseware server to the learner, as well as the time required for a response to the answer to be returned to the server by the learner.

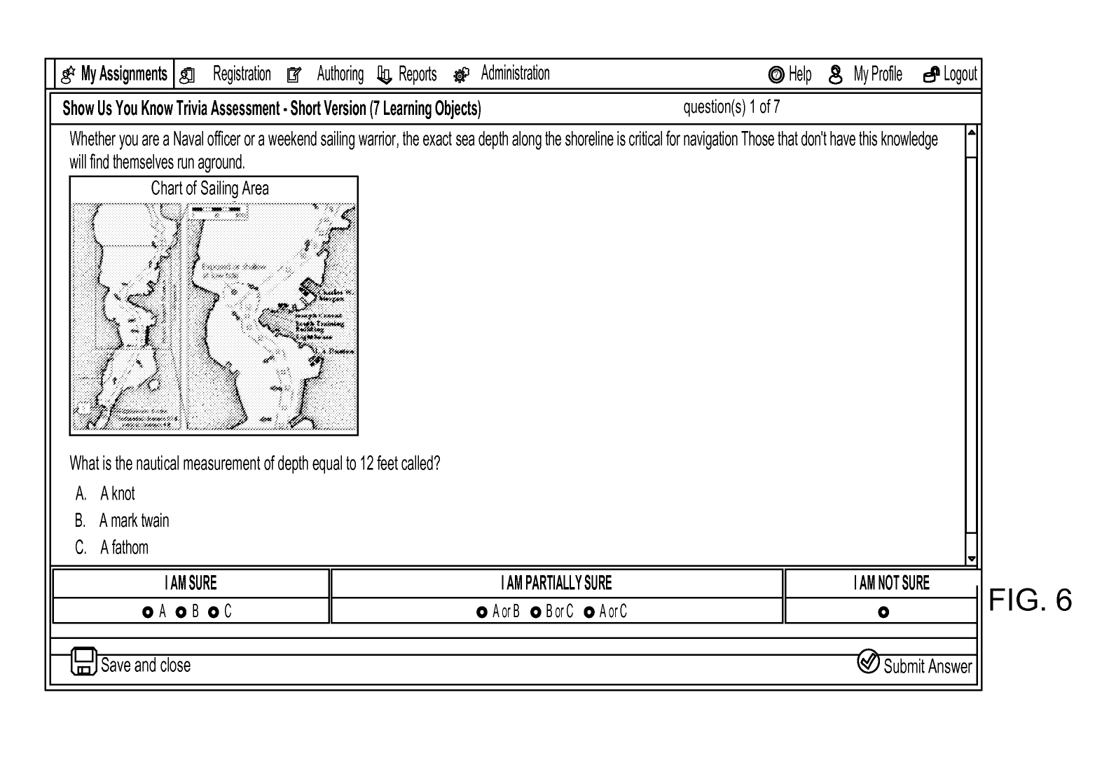

Various user interface embodiments are contemplated and are described. For example, learner answers may be selected on a user interface screen and dragged into an appropriate response area such as “confident”, “doubtful”, and “not sure” (e.g. FIG. 5). In other embodiments of the invention, the learner may be asked to select from one of seven different options that simultaneously capture a two-dimensional response for both knowledge and confidence (e.g. FIG. 6).

In the following discussion certain terms of art are used for ease of reference but it is not the intention here to limit the scope of these terms in any way other than as set forth in the claims.

ampObject: Refers to an individual question/answer presented to a learner or other user of the assessment and learning system (including introductory material), the learning information that is displayed to the learner (explanations and Additional Learning), and metadata associated with each ampObject that is available to the author and analyst. This ampObject structure was previously referred to in this document as a “learning object”.

Module: Refers to a group of ampObjects (learning objects in the system) that are presented to a learner in any given learning and/or assessment situation. The module is the smallest curriculum element that can be assigned to a learner.

### Compiling the Confidence Based (CB) Learning and Assessment Materials

To build, develop or otherwise compile a learning or assessment module in a CB format entails converting a standard assessment format (e.g., multiple-choice, true-false, fill-in-the-blank, etc.) into questions answerable by simultaneously providing a response as to the correctness of the answer (i.e., knowledge) and the learner's degree of certainty in that response (i.e., confidence).

Examples of two different implementations of the user interface for the assessment portion of the CBA or CBL environment are provided in FIGS. 5 and 6.

FIG. 5 is one example of a user interface illustrating such a question and answer format where learner answers may be selected on a user interface screen and either dragged into an appropriate response area such as “confident”, “doubtful”, and “not sure”, or by clicking on the desired answer (e.g., clicking on one answer will move it to the “confident” response field; clicking on a second answer will move both answers to the “doubtful” response field). Therefore, in response to the question presented, the learner is required to provide two-dimensional answers indicating both his/her substantive answer and level of confidence in that response.

FIG. 6 is an example of a user interface illustrating an alternative question and answer format with seven response options. In alignment with the previous example, the learner is required to provide two-dimensional answers indicating both his/her substantive answer and level of confidence in that choice.

In the example of FIG. 6, the one-dimensional choices are listed under the question. However, the learner is also required to simultaneously respond in a second dimension, which is categorized under headings “I Am Sure”; “I Am Partially Sure” and “I Am Not Sure”. The “I Am Sure” category includes the three single-choice answers (A-C). The “I Am Partially Sure” category allows the subject to choose between sets of any two single-choice answers (A or B, B or C, A or C). There is also an “I Am Not Sure” category that includes one specific “I Am Not Sure” answer. The three-choice seven-answer format is based on research that shows that fewer than three choices introduces error by making it easier to guess at an answer and get it right. More than three choices can both (a) increase the ability of the learner to discern between correct and incorrect answers by identifying congruity between incorrect answers, and (b) cause a level of confusion (remembering previous choices) that negatively impacts the true score of the test.

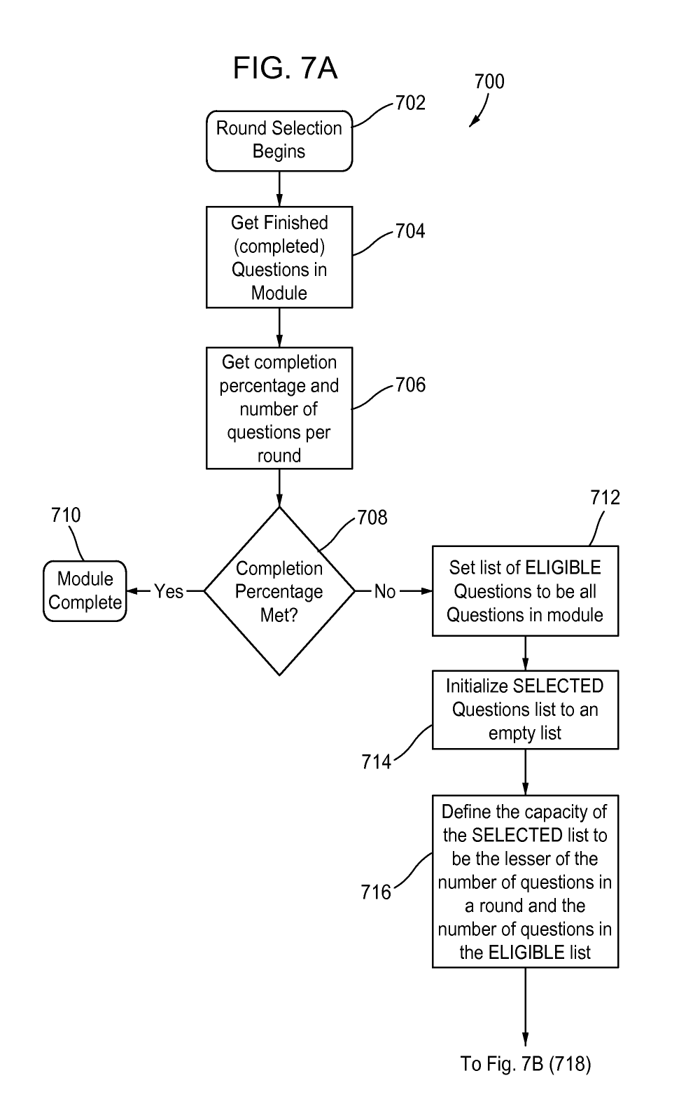

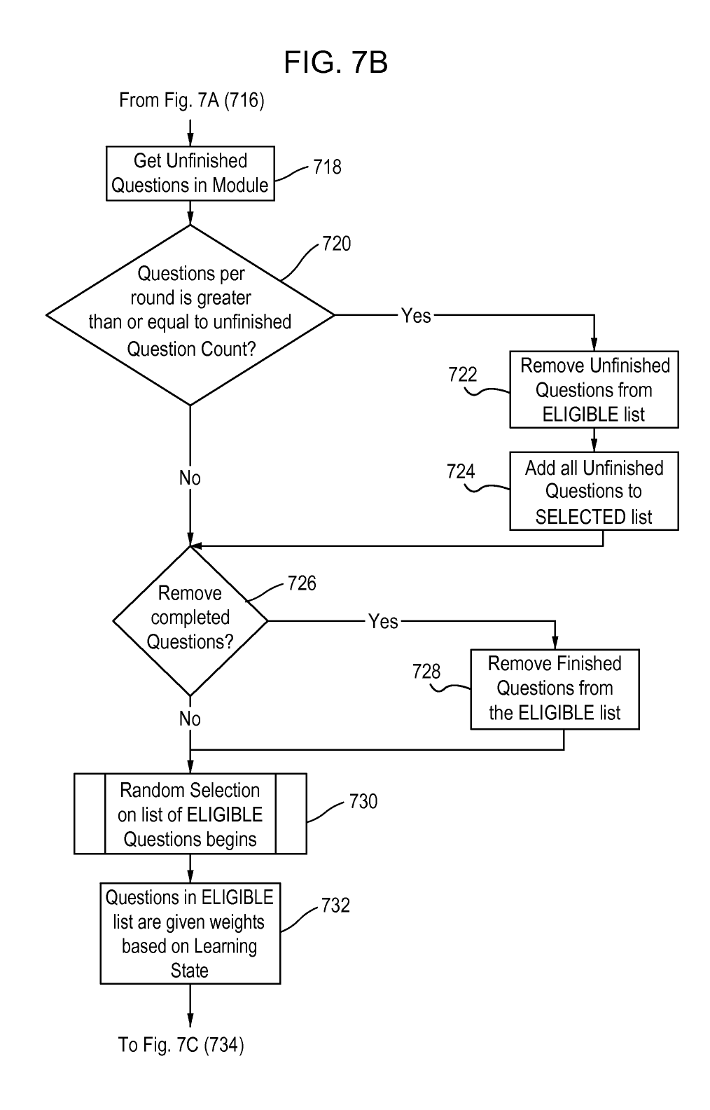

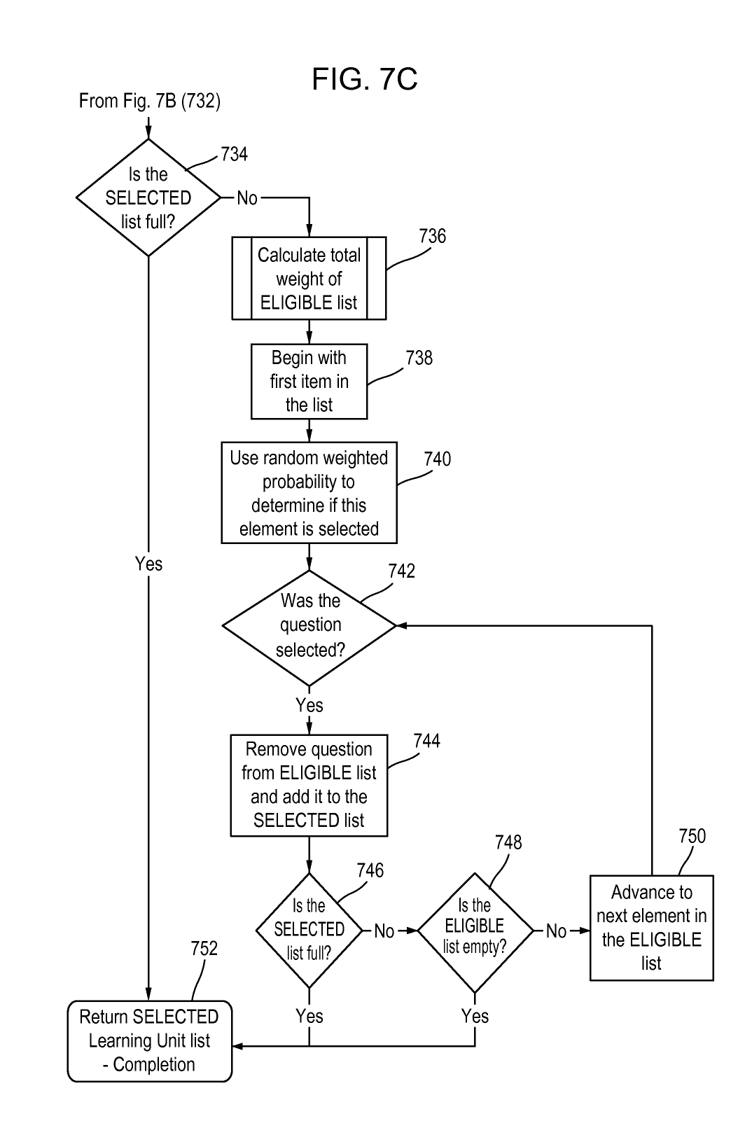

FIGS. 7A-7C illustrate a high-level overview of the adaptive learning framework structure embodied in aspects of the present invention. The overall methods and systems in accordance with the aspects disclosed herein adapt in real-time by providing assessment and learning programs to each learner as a function of the learner's prior responses. In accordance with other aspects of the present invention, the content of the learning and assessment system is delivered to every learner in a personalized manner depending upon how each learner answers the particular questions. Specifically, those responses will vary depending on the knowledge, skill and confidence manifest by each learner, and the system and its underlying algorithms will adaptively feed future assessment questions and associated remediation depending on the knowledge quality provided by the learner for each question.

### Increasing Retention by Adaptive Repetition

A learner's confidence is highly correlated with knowledge retention. As stated above, certain aspects ask and measure a learner's level of confidence. Further aspects of the present invention move further by requiring learners to demonstrate full confidence in their answers in order to reach true knowledge, thereby increasing knowledge retention. This is accomplished in part by an iteration step (Adaptive Repetition™). After individuals review the results of the material in the system as above, learners can retake the assessment as many times as necessary to reach mastery as demonstrated by being both confident and correct in that knowledge. Learning in accordance with this adaptively repetitive methodology in combination with non-one-dimensional assessment yields multiple personalized knowledge profiles, which allows individuals to understand and measure their improvement throughout the assessment process.

In one embodiment, when an individual retakes the formative assessment in a learning module, the questions are randomized, such that individuals do not see the same questions in the same order from the previous assessment. Questions are developed in a database in which there is a certain set of questions to cover a competency or set of competencies. To provide true knowledge acquisition and confidence of the subject matter (mastery), a certain number of questions are presented each time rather than the full bank of questions (spacing or chunking). Research demonstrates that such spacing significantly improves long-term retention.

Display of ampObjects (Questions) to Learners:

In some embodiments, questions (in ampObjects) are displayed to the learner in their entirety (all questions at once in a list) and the user also answers the questions in their entirety. In another embodiment, the questions are displayed one at a time. In accordance with further embodiments, learning is enhanced by an overall randomization of the way questions are displayed to a learner, and the number and timing of the display of ampObjects to the learner. Broadly speaking, the selected grouping of questions allows the system to better tailor the learning environment to a particular scenario. As set forth above, in some embodiments the questions and groups of questions are referred as ampObjects and modules, respectively. In one embodiment, the author may configure whether the ampObjects are “chunked” or otherwise grouped so that only a portion of the total ampObjects in a given module are presented in any given round of learning. The ampObjects may also be presented in either a randomized or sequential order to the user in each round or iteration of learning. The author of the learning system may select that answers within a given ampObject are always displayed in random order during each round of learning.

The randomization of question presentation may be incorporated into both the learning and assessment portions of the learning environment. In one embodiment, during the formative assessment portion of learning the questions and answers are displayed only in a random order during each question set of learning. Various other schemes can be applied to the order that learning objects are displayed to the user. For example, one type of “standard assessment” may require that the ampObjects be displayed in either random or sequential order during one assessment, or that they be displayed only as either sequential or random. In the “switches” section below, further details are shown that allow an author to “dial up” or dial down” the mastery level of the assessment.

Aspects here will use a weighing system to determine the probability of a question being displayed in any given round or set based on how the ampObject was previously answered. In one embodiment, there is a higher probability that a particular question will be displayed if it was answered incorrectly (confident and incorrect, or partially sure and incorrect) in a previous round.

With continuing reference to FIGS. 7A-7C, an algorithmic flow is shown that in general describes one embodiment of the logic utilized in accordance with question selection during a particular round of learning. Descriptions of each of the steps are included within the flow chart and the logic steps are illustrated at the various decision nodes within the flow chart to show the process flow.

### Point Scoring and Testing Evaluation Algorithms

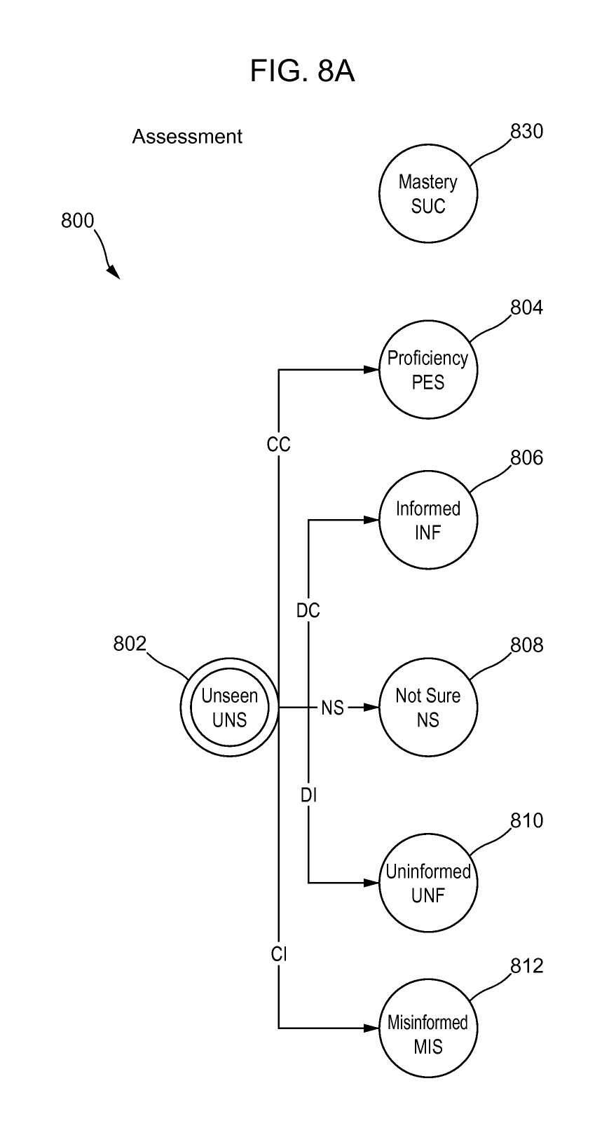

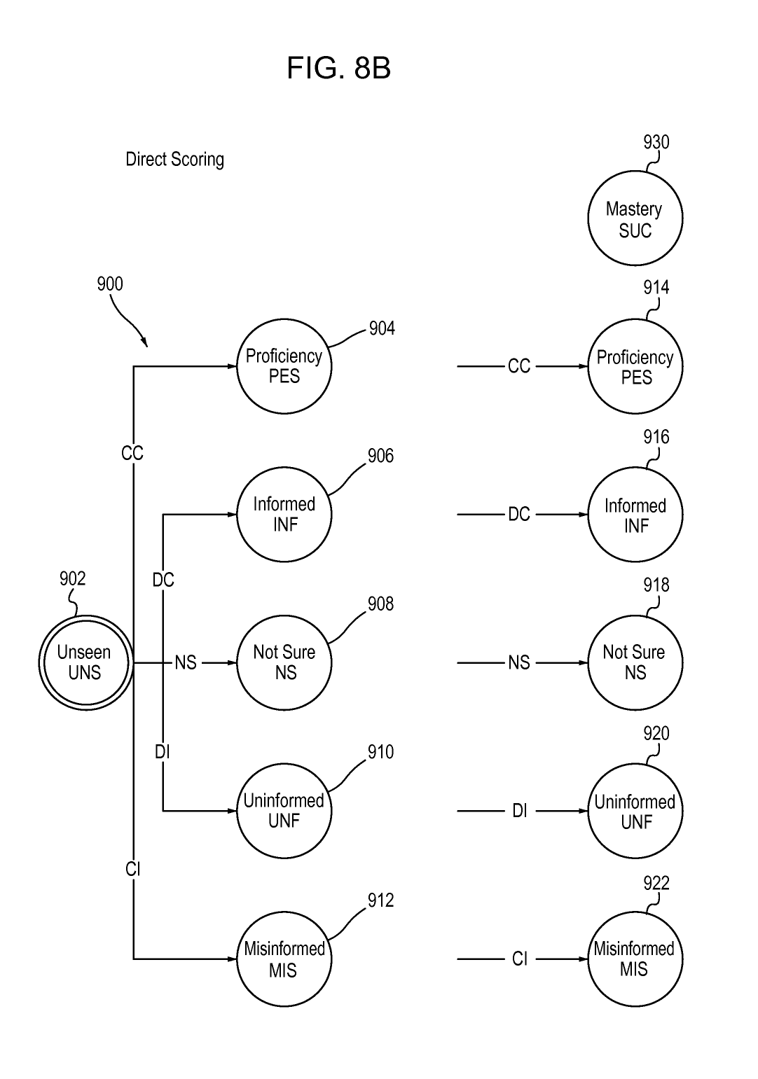

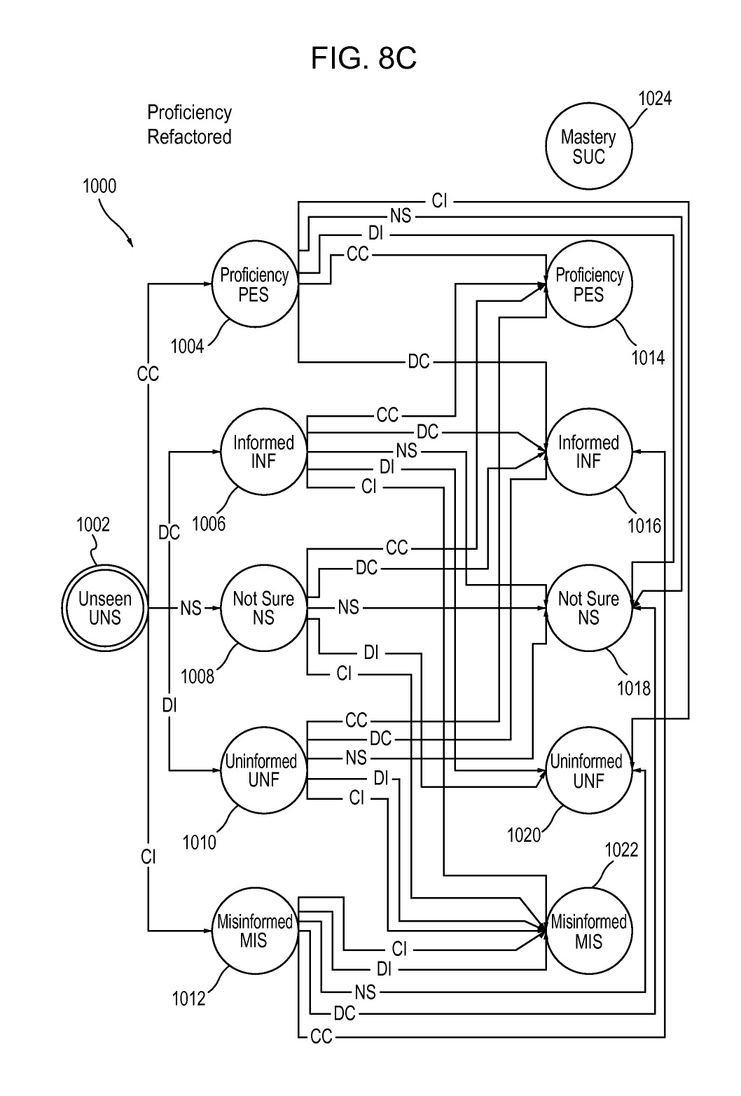

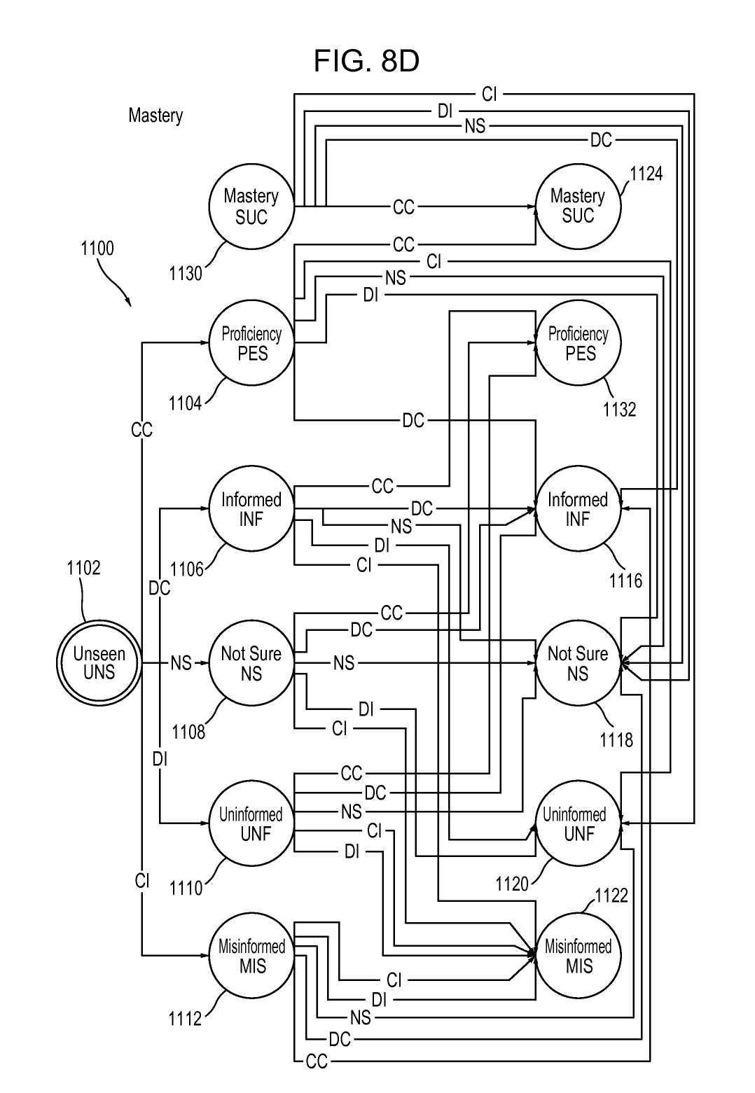

Aspects relating to the implementation of the knowledge assessment and testing system invoke various novel algorithms to evaluate and score a particular testing environment. FIGS. 8A-8D illustrate algorithmic flow charts that illustrate four “goal state” schemes for knowledge assessment and learning as used in connection with aspects of the present invention. FIG. 8A shows an initial assessment scheme, FIG. 8B shows a direct scoring scheme, FIG. 8C shows a “one time correct” proficiency scheme, and FIG. 8D shows a “twice correct” mastery scheme. The author or administrator of the system determines the appropriate goal state for a learner in a particular learning or assessment session. In FIGS. 8A-8D, the following nomenclature is used to describe any particular response to a question: CC=confident & correct, DC=doubt & correct, NS=not sure, DI=doubt & incorrect, CI=confident & incorrect.

With reference first to FIG. 8A, an assessment algorithm 800 is displayed where an initially unseen question (UNS) is presented to a learner at 802. Depending on the response from the learner, an assessment is made as to the knowledge and confidence level of that learner for that particular question. If the learner answers the question confidently and correctly (CC), the knowledge state is deemed “proficient” at 804. If the learner answers with doubt but correct, the knowledge state is deemed “informed” at 806. If the learner answers that he is not sure, the knowledge state is deemed “not sure” at 308. If the learner answers with doubt and is incorrect, the knowledge state is deemed “uninformed” at 810. Finally, if the learner answers confidently and is incorrect, the knowledge state is deemed “misinformed” at 812.

With reference to FIG. 8B, a direct scoring algorithm 900 is shown. The left portion of the direct scoring algorithm 900 (FIG. 8B) is similar to the assessment algorithm 800 (FIG. 8A) with the initial response categories mapping to a corresponding assessment state designation. With reference first to FIG. 8B, an assessment state algorithm 900 is displayed where an initially unseen question (UNS) is presented to a learner at 902. Depending on the response from the learner, an assessment is made as to the knowledge level state of that learner for that particular question. If the learner answers the question confidently and correctly (CC), the knowledge state is deemed “proficient” at 904. If the learner answers with doubt but correct, the knowledge state is deemed “informed” at 906. If the learner answers that he/she is not sure, the knowledge state is deemed “not sure” at 908. If the learner answers with doubt and is incorrect, the knowledge state is deemed “uninformed” at 910. Finally, if the learner answers confidently and is incorrect, the knowledge state is deemed “misinformed” at 912. In the algorithm described in FIG. 8B, when the same response is given twice for a particular question, the assessment state designation does not change and the learner is determined to have the same knowledge level for that particular question as reflected by the identical designations represented at 914 (proficient), 916 (informed), 918 (not sure), 920 (uninformed) and 922 (misinformed).

With reference to FIG. 8C, a one-time correct proficiency algorithm 1000 is shown. In FIG. 8C, an assessment of a learner's knowledge is determined by subsequent answers to the same question. As in FIGS. 8A and 8B an initial question is posed at 1002, and based on the response to that question, the learner's knowledge state is deemed either “proficient” at 1004, “informed” at 1006, “not sure” at 1008, “uninformed” at 1010, or “misinformed” at 1012. The legend for each particular response in FIG. 8C is similar to that in the previous algorithmic processes and as labeled in FIG. 8A. Based on the first response classification, a learner's subsequent answer to that same question will shift the learner's knowledge level state according to the algorithm disclosed in FIG. 8C. For example, referring to an initial question response that is confident and correct (CC) and therefore gets classified as “proficient” at 1004, if a user subsequently answers that same question as confident and incorrect, the assessment state of that user's knowledge of that particular question goes from proficient at 1004 to uninformed ay 1020. Following the scheme set forth in FIG. 8C, if that learner were to answer “not sure” at 1018 the assessment state would then be classified as “not sure”. The change in assessment state status factors in the varied answers to the same question. FIG. 8C details out the various assessment state paths that are possible with the various answer sets to a particular question. As another example shown in FIG. 8C, if a learner first answers “misinformed” at 1012 and then subsequently answers “confident and correct” the resulting assessment state would move to “informed” at 1016. Because FIG. 8C lays out a “proficiency” testing algorithm, it is not possible to obtain the “mastery” state 524.

With reference to FIG. 8D, a twice-correct mastery algorithm 1100 is shown. Similar to FIG. 8C, the algorithm 1100 shows a process for knowledge assessment that factors in multiple answers to the same question. As in prior figures an initial question is posed at 1102, and based on the response to that question, the learner's knowledge state is deemed either “proficient” at 1104, “informed” at 1106, “not sure” at 1108, “uninformed” at 1110, or “misinformed” at 1112. The legend for each particular response in FIG. 8D is similar to that in the previous algorithmic processes and as labeled in FIG. 8A. Based on the first response classification, a learner's subsequent answer to that same question will shift the learner's knowledge level state according to the algorithm disclosed in FIG. 8D. With FIG. 8D an additional “mastery” state of knowledge assessment is included at points 1130 and 1132, and can be obtained based on various question and answer scenarios shown in the flow of FIG. 8D. As one example, a question is presented to a learner at 1102. If that question is answered “confident and correct” the assessment state is deemed as “proficiency” at 1104. If that same question is subsequently answered “confident and correct” a second time, the assessment state moves to “mastery” at 1132. In this example the system recognizes that a learner has mastered a particular fact by answering “confident and correct” twice in a row. If the learner first answers the question presented at 1102 as “doubt and correct”, and thus the assessment state gets classified as “informed” at 1106, in order to achieve “mastery” he/she would need to answer the question again as “confident and correct” twice in a row after that in order to have the assessment state classified as “mastery.” FIG. 8D details out the various assessment paths that are possible with the various answer sets to a particular question for the mastery state algorithm.

In the example of FIG. 8D, there are several possible paths to the “mastery” knowledge state. However, for each of these potential paths it is required that the learner answer a particular ampObject correctly and confidently twice in row. In one scenario, if a learner is already at a state of mastery for a particular ampObject, and then answers that question other than “confident and correct”, the knowledge state will be demoted to one of the other states, depending on the specific answer given. The multiple paths to mastery depending on the learner response to any given question creates an adaptive, personalized assessment and learning experience for each user.

In each of the embodiments discussed above, an algorithm is implemented that performs the following general steps:
1) Identifies a goal state configuration as defined by the author,
2) Categorizes the learner progress against each question in each round of learning relative to the goal state using the same categorization structure, and
3) The display of ampObjects in the next round of learning are dependent on the categorization of the last response to the question in each ampObject in earlier rounds of learning.

More details and embodiments of the operation of these algorithms are as follows:

Identification of a goal state configuration: The author of a given knowledge assessment may define various goal states within the system in order to arrive at a customized knowledge profile and to determine whether a particular ampObject (e.g., question) is deemed as being complete. The following are additional examples of these goal states as embodied by the algorithmic flow charts described above and in conjunction with FIGS. 8A-8D:
a. 1-time (1×) Correct (Proficiency)—The learner must answer “confident+correct” one (1) time before the ampObject is deemed as being complete. If the learner answers “confident+incorrect” or “partially sure+incorrect”, the learner must answer confident+correct two (2) times before the ampObject is deemed as being complete and the state of proficiency for that ampObject has been achieved by the learner.
b. 2-times (2×) correct (Mastery)—The learner must answer “confident and correct” twice before the ampObject is deemed as being complete.
c. Based on the scoring configuration selected by the author or administrator, once an ampObject is labeled as “complete” per one of the above scenarios it is removed from further testing rounds.

Categorizing learner progress: Certain aspects of the system are adapted to categorize the learner's progress against each question (ampObject) in each round of learning, relative to the goal state (described above) using similar categorization structures as described herein, e.g. “confident+correct”, “confident+incorrect”, doubt+correct”, “doubt+incorrect” and “not sure.”

Subsequent Display of ampObjects: The display of an ampObject in a future round of learning is dependent of the categorization of the last response to the question in that ampObject relative to the goal state. For example, a “confident+incorrect” response has the highest likelihood that it will be displayed in the next round of learning.

The algorithm or scoring engine creates a comparison of the learner's responses to the correct answer. In some embodiments of the invention, a scoring protocol is adopted, by which the learner's responses or answers are compiled using a predefined weighted scoring scheme. This weighted scoring protocol assigns predefined point scores to the learner for correct responses that are associated with an indication of a high confidence level by the learner. Such point scores are referred herein as true knowledge points, which would reflect the extent of the learner's true knowledge in the subject matter of the test query. Conversely, the scoring protocol assigns negative point scores or penalties to the learner for incorrect responses that are associated with an indication of a high confidence level. The negative point score or penalty has a predetermined value that is significantly greater than knowledge points for the same test query. Such penalties are referred herein as misinformation points, which would indicate that the learner is misinformed of the matter. The point scores are used to calculate the learner's raw score, as well as various other performance indices. U.S. Pat. No. 6,921,268, issued on Jul. 26, 2005 provides an in-depth review of these performance indices and the details contained therein are incorporated by reference into the present application.

Documenting the Knowledge Profile: The primary goal of the knowledge profile is to provide the learner with continuous feedback regarding his/her progress in each module. Embodiments of the system use various manifestations of the knowledge profile. However, the following timing is generally used to display the knowledge profile to the learner:

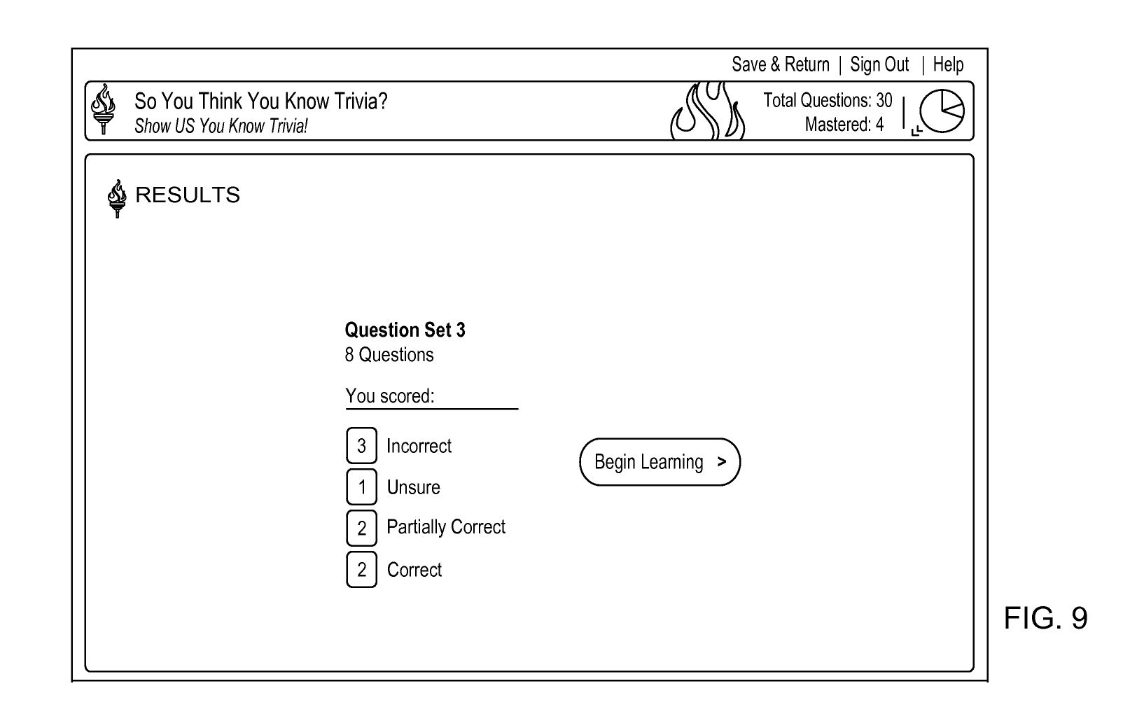

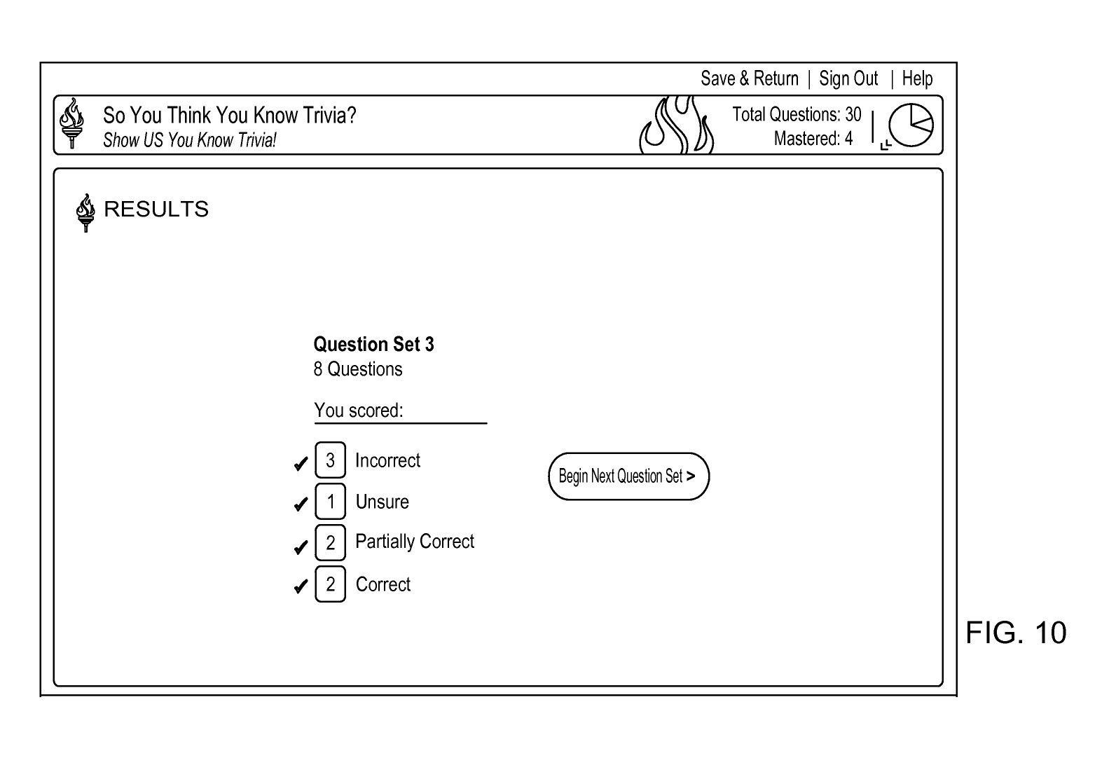

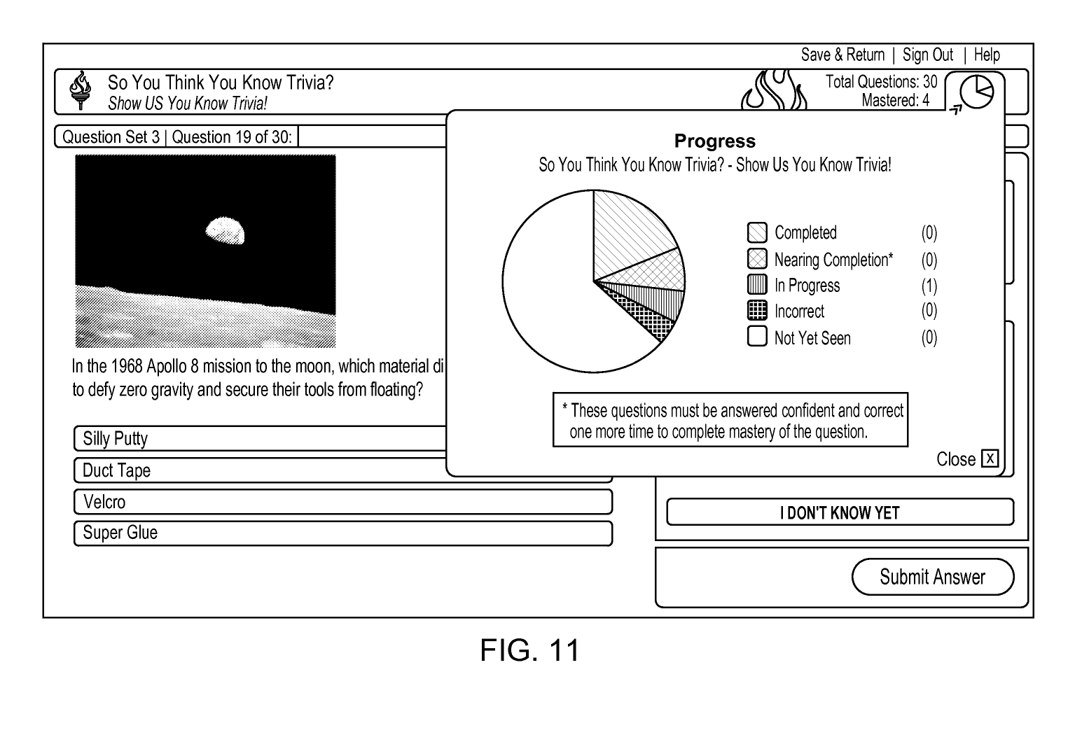

Learning Modules:
Display of learner progress at the end of any formative assessment phase of the round prior to the learning phase within any given round of learning for a module (see e.g. FIG. 9)
Display of learner progress at the end of any given round of learning for a module (i.e., after a learner has completed both the formative assessment and learning phases within any given round) (see e.g. FIG. 10) Display of learner progress at any state within learning (see e.g. FIG. 11)

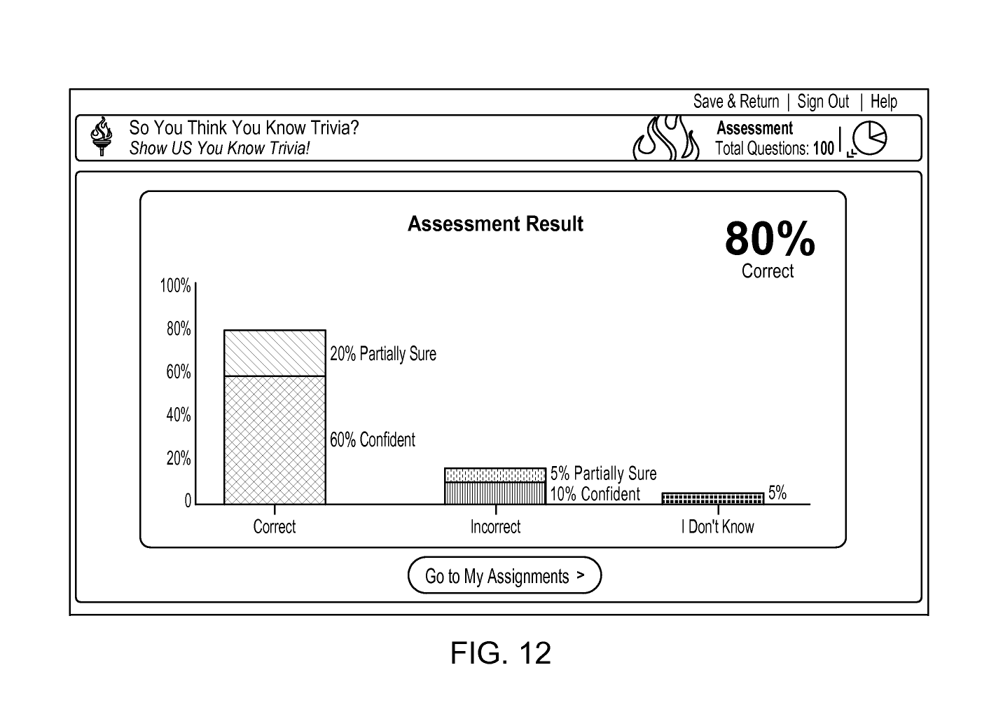

Assessment Modules:
Display of learner's assessment results after completing the assessment (see e.g. FIG. 12)

One embodiment also provides in the upper right corner of the Learning application (in the form of a small pie chart) a summary of the learner's progress for that module (FIG. 5). This summary is available in both the learning phases of any given round of learning for a module. In addition, when the learner clicks on the pie chart, a more detailed progress summary is provided in the form of a pie chart (FIG. 11).

One embodiment also displays to the learner, after each response to an assessment (in both learning and assessment modules), whether his/her answer is confident+correct, partially sure+correct, unsure, confident+incorrect, or partially sure+incorrect. However, the correct answer is not provided at that time. Rather, the goal is to heighten the anticipation of the learner in any particular response so that he/she will be eager to view the correct answer and explanation in the learning phase of any given round.

In most embodiments, the documented knowledge profile is based on one or more of the following pieces of information: 1) The configured goal state of the module (e.g. mastery versus proficiency) as set by the author or registrar; 2) the results of the learner's formative assessment in each round of learning, or within a given assessment; and 3) how the learner's responses are scored by the particular algorithm being implemented. As needed or desired, the knowledge profile may be made available to the learner and other users. Again, this function is something that may be selectively implemented by the author or other administrator of the system.

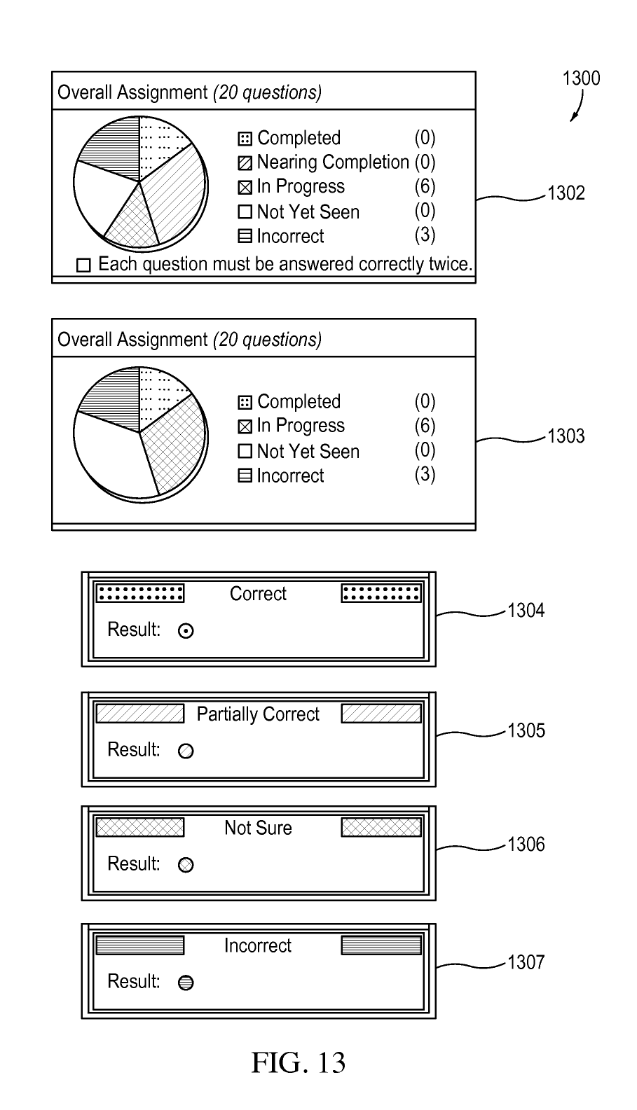

FIG. 13 illustrates several examples of a displayed knowledge profile 1300 from another embodiment of the Learning application that may be generated as a result of a formative assessment being completed by a user. In FIG. 13, charts 1302 and 1304 illustrate overall knowledge profiles that may be delivered to a learner by showing the categorization of responses in a module made up of 20 ampObjects. Instant feedback for any particular question given by a learner can be given in the form shown in 1306, 1308, 1310 and 1312.

Other embodiments have displayed a simple list of response percentages separated by categories of responses, or the cumulative scores across all responses based on the scores assigned to each response.

In one embodiment, during the assessment phase of each round of learning the following data is continuously displayed and updated as the learner responds to each question: (a) The number of questions in that Question Set (which is determined by the author or registrar); which question from that question set is currently being displayed to the learner (1 of 6; 2 of 6; etc.); (b) which question set is currently being displayed to the learner (e.g., “Question Set 3”); (c) the total number of questions (ampObjects) in the module; and (d) the number of ampObjects that have been completed (1× Correct scoring) or mastered (2× Correct scoring).

The number of question sets in a module is dependent on: (a) The number of ampObjects in a module, (b) the number of ampObjects displayed per question set, (c) the scoring (1× Correct or 2× Correct), (d) the percentage required for ‘passing’ a particular module (default is 100%), (e) and the number of times a learner must respond to an ampObject before he/she completes (1× Correct) or masters (2× Correct) each ampObject.

In one embodiment, during the learning phase of each question set, the following may be continuously displayed as the learner reviews the questions, answers, explanations and Additional Learning elements for each ampObject: (a) The total number of questions (ampObjects) in the module; (b) the number of questions completed (1× Correct) or mastered (2× Correct); (c) a progress summary graph, such as a pie chart showing the number of confident and correct responses at that point in time; and (d) a detailed progress window providing real-time information regarding how the responses have been categorized.

In the current embodiment of the system, in an assessment module (i.e., where only the assessment, and no learning, is displayed to the learner) learner progress is displayed to the learner as follows: (a) The total number of questions in that module; and (b) which question from that module is currently being displayed to the learner (1 of 25; 2 of 25; etc.). In assessment modules all questions in that module are presented to the learner in one round of assessment. There is no parsing of ampObjects into questions sets, as questions sets are not pertinent to assessments.

Upon completion of the assessment module, the learner is provided with a page summarizing one or more of the following:
Overall score received in the assessment, which is the sum of the percent Confident+Correct and Partially Sure+Correct
Graphical displays of:
   Correct responses parsed as:
      Percent answered Confident+Correct
      Percent answered Partially Sure+Correct
   Incorrect responses parsed as:
      Percent answered Confident+Incorrect
   Percent answered Partially Sure+Incorrect
   Percent answered I Don't Know

System Roles: In further embodiments, in addition to the system roles stated above (Administrator, Author, Registrar, Analyst, and Learner) there are additional roles that attend to detailed tasks or functions within to the five overall roles. These additional roles include:
Manager: Manage a staff of Authors, Resource Librarians, and Translators.
Resource Librarian: Manage a library of resources that can be used to create learning content.
Publisher: Manage the organizational structure of the curriculum, and has ability to formally publish a module.
Translator: Translate content into another language, and adjust for localization where appropriate.
Reviewer: Provide feedback on content.
CMS Administrator: Configure the content management system (CMS) for use within an organization.

In other embodiments, the system roles may be grouped by the overall system component, such as within the Content Management System (CMS) or Registration and Data Analytics (RDA).

### Example of Functional Steps

In one embodiment one or more of the following steps are utilized in the execution of a learning module. One or more of the steps set forth below may be effected in any order:
a. The author plans and develops the ampObject(s).
b. The ampObjects are aggregated into modules.
c. The modules are aggregated into higher order containers. These containers may optionally be classified as courses or programs.
d. The developed curriculum is tested to ensure proper functionality.
e. The curriculum is published and made available for use.
f. One or more learners are enrolled in the curriculum.
g. The learner engages in the assessment and/or learning as found in the curriculum.
h. The learning can be chunked or otherwise grouped so that in a given module the learner will experience both an assessment and a learning phase to each round of learning.
i. A personalized or otherwise adaptive knowledge profile is developed and displayed for each learner on an iterative basis for each round of learning, with the questions and associated remediation provided in each round of learning being made available in a personalized, adaptive manner based on the configuration of the module and how that configuration modifies the underlying algorithm.
j. During the assessment phase, a proficiency or mastery score is shown to the learner after completion of a module.
k. During the learning phase immediate feedback is given to the learner upon submission of each answer.
l. Feedback is given regarding knowledge quality (categorization) after completion of each phase of assessment within a round of assessment and learning.
m. Feedback is given regarding knowledge quality (categorization) across all rounds completed to date and progress towards proficiency or mastery in any given module.
n. The learner is then presented with an adaptive, personalized set of ampObjects per module per round of learning depending on how he/she answers the questions associated with each ampObject. The adaptive nature of the system is controlled by a computer-implemented algorithm that determines how often a learner will see ampObjects based on the learner's response to those ampObjects in previous rounds of learning. This same knowledge profile is captured in a database and later copied to a reporting database.

Similar functional steps are used in the execution of an assessment module. However, for assessment modules, no learning phase is present, and ampObjects (only the introduction, question, answers) are presented in one contiguous grouping to the learner (not in question sets).

### Within the Content Management System (CMS)

Authoring of learning objects (ampObjects) may include pre-planning and the addition of categorical data to each learning object (e.g., learning outcome statement; topic; sub-topic; etc.). In addition, ampObjects may be aggregated into modules, and modules organized into higher order containers (e.g., courses, programs, lessons, curricula). The CMS may also be adapted to conduct quality assurance review of a curriculum, and publish a curriculum for learning or assessment.

### Within the Registration and Data Analytics (RDA) Application

The ability to enroll a learner in a curriculum, and allow the learner to engage in an assessment and/or learning as found in the curriculum. In addition to the feedback provided directly to the learner in the Learning application (as described above), reports associated with learning and/or assessment may also be accessed in the RDA by particular roles (e.g., analyst, instructor, administrator).

### Reporting Functionality in the RDA

In accordance with another aspect, reports can be generated from the knowledge profile data for display in varied modalities to learners or instructors. Specifically, in the RDA reports can be accomplished through a simple user interface within a graphical reporting and analysis tool that, for example, allows a user to drill down into selected information within a particular element in the report. Specialty reporting dashboards may be provided such as those adapted specifically for instructors or analysts. Reports can be made available in formats such as .pdf, .csv, or many other broadly recognized data file formats.

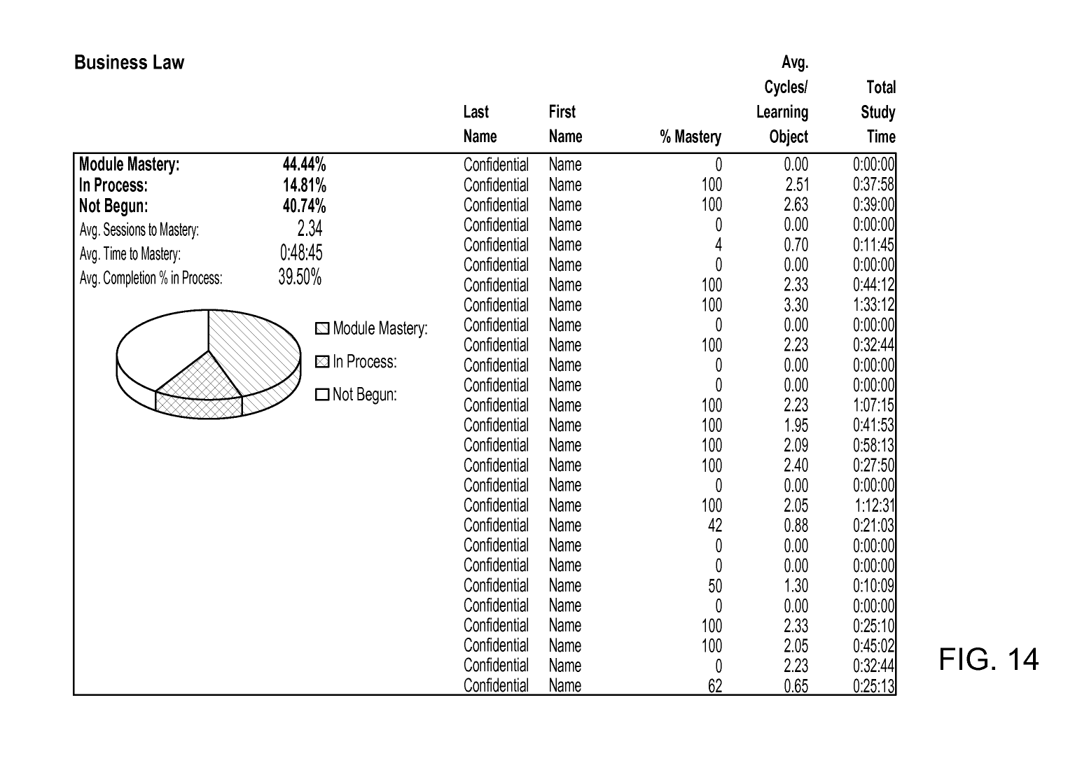

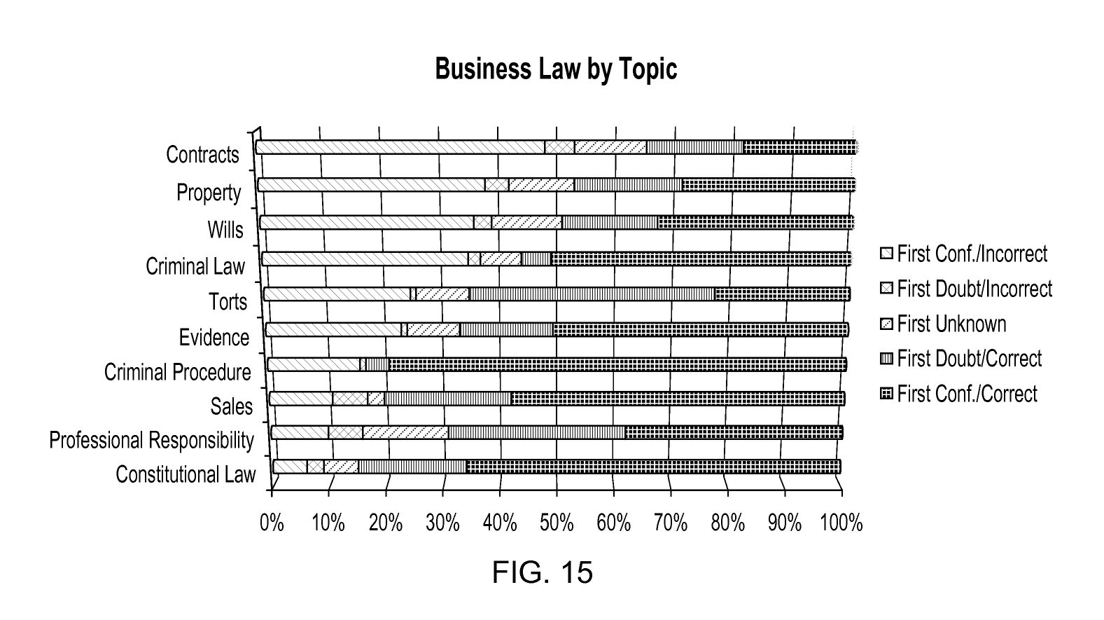

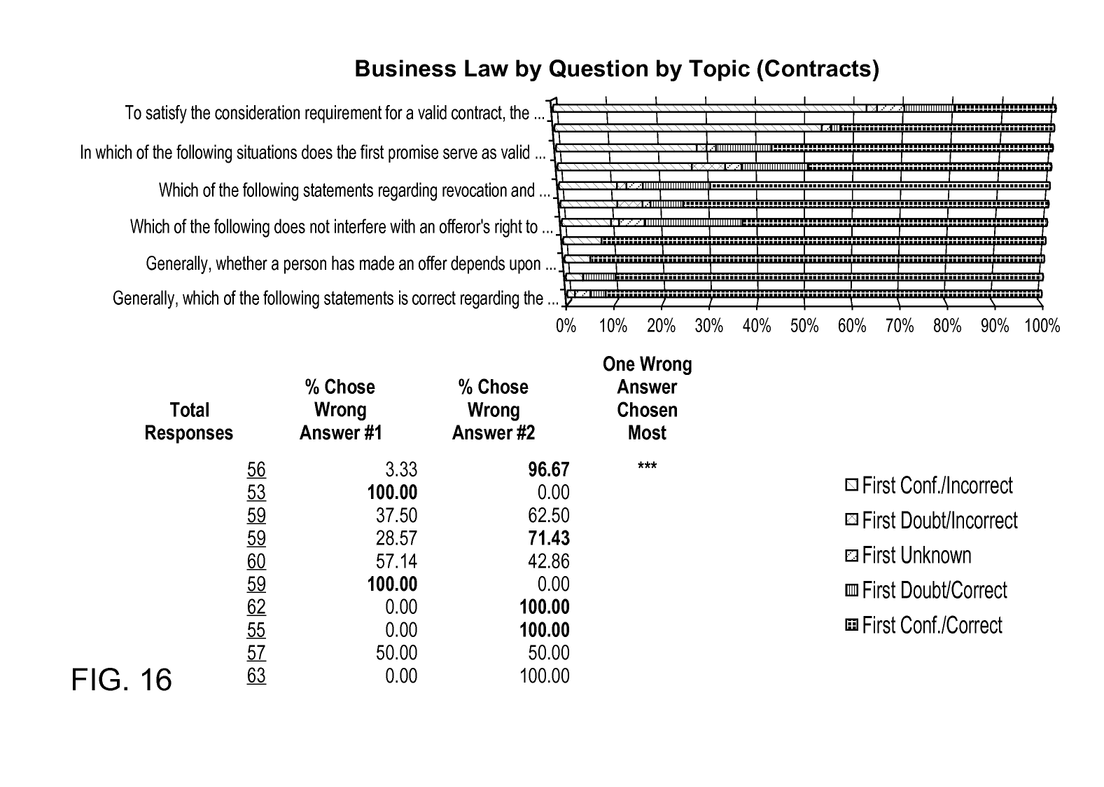

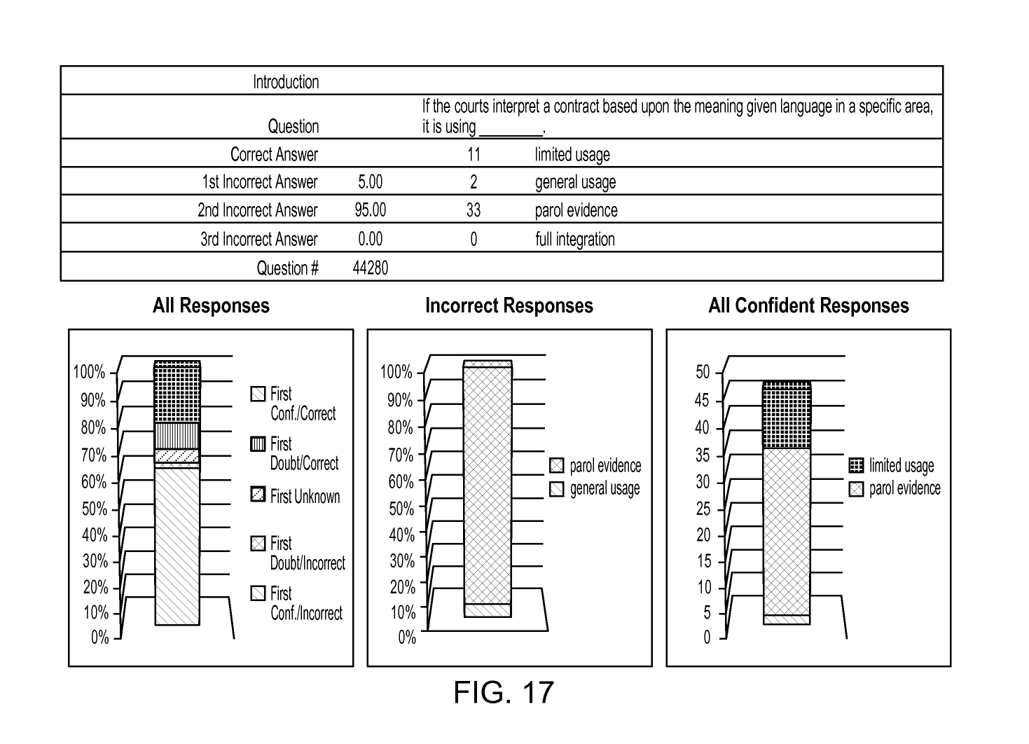

FIGS. 14-17 illustrate various representative reports that can be utilized to convey progress in a particular assignment or group of assignments. FIG. 14 shows the progress of a group of students that have been assigned a particular module prior to all students having completed the assignment. FIG. 15 shows the first responses to each ampObject in a curriculum for a group of students, and those responses are sorted by topic and by response category (e.g., confident+incorrect; doubt+incorrect; etc.). FIG. 16 shows the first responses by a group of students to each ampObject for that curriculum for a selected topic, and summaries of (a) the number of responses that made up the report (which is equivalent to the number of learners that responded), and (b) the percent of responses that were either incorrect answer #1 or #2. FIG. 17 shows a detailed analysis of the first responses to a particular ampObject. These are just a few of the many reports that can be generated by the system.

### Hardware, Data Structure and Machine Implementation

As described above, the system described herein may be implemented in a variety of stand-alone or networked architectures, including the use of various database and user interface structures. The computer structures described herein may be utilized for both the development and delivery of assessments and learning materials, and may function in a variety of modalities including a stand-alone system or network distributed, such as via the world wide web (Internet), intranets, mobile networks, or other network distributed architectures. In addition, other embodiments include the use of multiple computing platforms and computer devices, or delivered as a stand-alone application on a computing device with, or without, interaction with the client-server components of the system.

In one specific user interface embodiment, answers are selected by dragging the answer to the appropriate response area. These may be comprised of a “confident” response area, indicating that the learner is very confident in his/her answer selection; a “doubtful” response area, indicating that the learner is only partially certain of his/her answer selection; and a “not sure” response area, indicating that the learner is not willing to commit that he/she knows the correct answer with any level of certainty. Various terms may also be used to indicate the degree of confidence, and the examples of “confident”, “doubtful”, and “not sure” indicated above are only representative. For example, “I am sure” for highly confident, “I am partially sure” for a doubtful state, and “I don't know yet” for a not sure state. In one embodiment representing an assessment program, only a single “I Am Partially Sure” response box may be provided; i.e., the learner can select only one answer within a “partially sure” response.

### Chunked Learning:

In accordance with another aspect, the author of a learning module can configure whether or not the ampObjects are chunked or otherwise grouped so that only a portion of the total ampObjects in a give module are presented in any given round of learning. All “chunking” or grouping is determined by the author through a module configuration step. The author can chunk learning objects at two different levels in a module, for example, by the number of learning objects (ampObjects) included in each module, and by the number of learning objects displayed per question set within a learning event. In this embodiment completed ampObjects are removed based on the assigned definition of “completed.” For example, completed may differ between once (1×) correct and twice (2×) correct depending of the goal settings assigned by the author or administrator. In certain embodiments, the author can configure whether or not the learning objects are ‘chunked’ so that only a portion of the total learning objects in a given module are presented in any given question set of learning. Real-time analytics can also be used to optimize the number of learning objects displayed per question set of learning.

ampObject Structure

ampObjects as described herein are designed as “reusable learning objects” that manifest one or more of the following overall characteristics: A learning outcome statement (or competency statement or learning objective); learning required to achieve that competency; and an assessment to validate achievement of that competency. As described previously for learning objects, the basic components of an ampObject include: an introduction; a question, the answers (1 correct answer, and 2-4 incorrect answers), an explanation (the need to know information); an optional “Additional Learning” information (the nice to know information); metadata (such as the learning outcome statement, topic, sub-topic, key words, and other hierarchical or non-hierarchical information associated with each ampObject); and author notes. Through reporting capabilities in the system, the author has the capability to link a particular metadata element to the assessment and learning attributable to each ampObject, which has significant benefits to downstream analysis. Using a Content Management System (“CMS”), these learning objects (ampObjects) can be rapidly re-used in current or revised form in the development of learning modules and curricula.

### Shadow Question Groupings

In another embodiment, shadow questions may be utilized that are associated with the same competency (learning outcome; learning objective). In one embodiment, the author associates relevant learning objects into a shadow question grouping. If a learner receives a correct score for one question that is part of a shadow question group, then any learning object in that shadow question is deemed as having been answered correctly. The system will pull randomly (without replacement) from all the learning objects in a shadow group as directed by one or more of the algorithms described herein. For example, in a module set up with 1× Correct algorithm, the following procedure may be implemented:
a. The first time the learner is presented with a learning object from a shadow question group, he/she answers confidently, and that response is Confident and Incorrect;
b. The next time the learner is presented with a learning object from that same shadow question group, a different question is randomly pulled from that shadow group, he/she answers confidently, and that response is Confident and Correct;
c. The next time the learner is presented with a learning object from that same shadow question group, a different question is randomly pulled from that shadow group (if additional learning objects are still available in that shadow question group), he/she answers confidently, and that response is Confident and Correct.
   In the above scenario, that shadow question group is considered mastered, and no additional learning objects from that shadow question group will be displayed to the learner.

### Module Structure

Modules serve as the “container” for the ampObjects as delivered to the user or learner, and are therefore the smallest available organized unit of curriculum that a learner will be presented with or otherwise experience in the form of an assignment. As noted above, each module preferably contains one or more ampObjects. In one embodiment it is the module that is configured according to the algorithm. A module can be configured as follows:
a. Goal State: This may be set as a certain number of correct answers, e.g. once (1×) correct or twice (2×) correct, etc.
b. Removal of Mastered (Completed) ampObjects: Once a learner has reached the goal state for a particular ampObject, it is removed from the module and is no longer presented to the learner.
c. Display of ampObjects: The author or administrator can set whether the entire list of ampObjects are displayed in each round of questioning, or whether only a partial list is displayed in each round.
d. Completion Score: The author or administrator can set the point at which the learner is deemed to have completed the round of learning, for example, by the achievement of a particular score.

### Curriculum Structure

While the curriculum structure may be open-ended in certain embodiments, the author or administrator has the ability to control the structure regarding how the curriculum is delivered to the learner. For example, the modules and other organizational units (e.g., program, course, lesson) may be renamed or otherwise modified and restructured. In addition, modules can be configured such that it is displayed to the learner as a stand-alone assessment (summative assessment), or as a learning module that incorporates both the formative assessment and learning capabilities of the system.

### Learner Dashboard

As a component of the systems described herein, a learner dashboard is provided that displays and organizes various aspects of information for the user to access and review. For example, a user dashboard may include one or more of the following:

### My Assignments Page

This includes in one embodiment a list of current assignments with one or more of the following status states (documenting the completion state for that module by the student or reviewer): Start assignment, Continue Assignment, Review, Start Refresher, Continue Refresher, Review Content (reviewer only). Also included in the My Assignments page is curriculum information, such as general background information about the aspects of the current program (e.g., a summary or overview of a particular module), and the hierarchy or organization of the curriculum. The assignments page may also include pre- and post-requisite lists such as other modules or curricula that may need to be taken prior to being allowed to access a particular assignment or training program. Upon completion (mastery) of a module, a Refresher Module and a Review Module will be presented to the learner. The Refresher Module allows the learner to re-take the module using a modified 1× correct algorithm. The Review Module displays the progress of a particular learner through a given assessment or learning module (a historical perspective for assessments or learning modules taken previously), with the display of ampObjects in that module sorted based on how much difficulty the learner experienced with each ampObject (those for which the learner experienced the greatest difficulty being listed first). The Review Content link is presented only for those individuals in the Reviewer role.

### Learning Pages

This may include progress dashboards displayed during a learning phase (including both tabular and graphical data; see FIGS. 9, 10 and 11 for example representations). The learning page may also include the learner's percentage responses by category, the results of any prior round of learning and the results across all rounds that have been completed.

### Assessment Pages

This may include a progress dashboard displayed after assessment (both tabular and graphical data; see FIG. 12 as a potential representation).

### Reporting and Time Measurement

A reporting role (Analyst) is supported in various embodiments. In certain embodiments, the reporting function may have its own user interface or dashboard to create a variety of reports based on templates available within the system, such as through the Registration and Data Analytics (RDA) application. Standard and/or customized report templates may be created by an administrator and made available to any particular learning environment. Reports so configured can include the ability to capture the amount of time required by the learner to answer each ampObject and answer all ampObjects in a given module. Time is also captured for how much time is spent reviewing the answers. See e.g. FIG. 14 as a potential representation. Patterns generated from reporting can be generalized and additional information gleaned from the trending in the report functions. See FIGS. 14-17 as a potential representation. The reporting functions allow administrators or teachers to figure out where to best spend time in further teaching. In addition, an Instructor Dashboard may be incorporated to enable specific reports and reporting capabilities not necessarily available to the learner.

### Other System Capabilities:

Automation of Content Upload: In accordance with other aspects, the systems described herein may be adapted to utilize various automated methods of adding ampObjects to the system. Code may be implemented within the learning system to read, parse and write the data into the appropriate databases. The learning system may also enable the use of scripts to automate upload from previously formatted data e.g. from csv or xml into the learning system. In addition, in some embodiments a custom-built rich-text-format template can be used to capture and upload the learning material directly into the system and retain formatting and structure.

In some embodiments, the learning system supports various standard types of user interactions used in most computer applications, for example, context-dependent menus appear on a right mouse click, etc. Some embodiments of the system also include several additional features such as drag and drop capabilities and search and replace capabilities.

Data Security: Aspects of the present invention and various embodiments use standard information technology security practices to safeguard the protection of proprietary, personal and/or other types of sensitive information. These practices include (in part) application security, server security, data center security, and data segregation. For example, for application security, each user is required to create and manage a password to access his/her account; the application is secured using https; all administrator passwords are changed on a repeatable basis; and the passwords must meet strong password minimum requirements. For example, for server security, all administrator passwords are changed on a pre-defined basis with a new random password that meets strong password minimum requirements, and administrator passwords are managed using an encrypted password file. For data segregation, the present invention and its various embodiments use a multi-tenant shared schema where data is logically separated using domain ID, individual login accounts belong to one and only one domain (including administrators), all external access to the database is through the application, and application queries are rigorously tested. In other embodiments, the application can be segmented such that data for selected user groups are managed on separate databases (rather than a shared tenant model).

### Switches

A learning system constructed in accordance with aspects of the present invention uses various “Switches” in its implementation in order to allow the author or other administrative roles to ‘dial up’ or ‘dial down’ mastery that learner's must demonstrate to complete the modules. A “Switch” is defined as a particular function or process that enhances (or degrades) learning and/or memory. The functionality associated with these switches is based on relevant research in experimental psychology, neurobiology, and gaming. Examples of some (partial list) of the various switches incorporated into the learning system described herein are expanded upon below. The implementation of each switch will vary depending on the particular embodiment and deployment configuration of the present invention.

Repetition (Adaptive Repetition): An algorithmically driven repetition switch is used to enable iterative rounds of questioning to a learner in order to achieve mastery. In the classical sense, repetition enhances memory through the purposeful and highly configurable delivery of learning through iterative rounds. The Adaptive Repetition switch uses formative assessment techniques, and are in some embodiments combined with the use of questions that do not have forced-choice answers. Repetition in the present invention and various embodiments can be controlled by enforcing, or not enforcing, repetition of assessment and learning materials to the end-user, the frequency of that repletion, and the degree of chunking of content within each repetition. In other embodiments, the use of “shadow questions” are utilized in which the system requires that the learner demonstrate a deeper understanding of the knowledge associated with each question group. Because the ampObjects in a shadow question group are all associated with the same competency, display of the various shadow questions enables a more subtle yet deeper form of Adaptive Repetition.

Priming: Pre-testing aspects are utilized as a foundational testing method in the system. Priming through pre-testing initiates the development of some aspect of knowledge memory traces that is then reinforced through repetitive learning. Learning using aspects of the present invention opens up a memory trace with some related topic, and then reinforces that pathway and creates additional pathways for the mind to capture specific knowledge. The priming switch can be controlled in a number of ways in the present invention and its various embodiments, such as through the use of a formal pre-assessment, as well as in the standard use of formative assessment during learning.

Progress: A progress switch informs the learner as to his/her progress through a particular module, and is presented to the user in the form of a graphic through all stages of learning.

Feedback: A feedback switch includes both immediate feedback upon the submission of an answer as well as detailed feedback in the learning portion of the round. Immediate reflection to the learner as to whether he/she got a question right or wrong has a significant impact on attention of the learner and performance as demonstrated on post-learning assessments. The feedback switch in the present invention and various embodiments can be controlled in a number of ways, such as through the extent of feedback provided in each ampObject (e.g., providing explanations for both the correct and incorrect answers, versus only for the correct answers), or through the use of both summative assessments combined with standard learning (where the standard learning method incorporates formative assessment). In addition, in learning modules the learner is immediately informed as to the category of his/her response (e.g., confident and correct; partially sure and incorrect; etc.).

Context: A context switch allows the author or other administrative roles to simulate the proper or desired context, such as simulating the conditions required for application of particular knowledge. For example, in a module with 2× correct scoring, the author can configure the module to remove images or other information that is not critical to the particular question once the learner has provided a Confident+Correct response. The image or other media may be placed in either the introduction or in the question itself and may be deployed selectively during the learning phase or routinely as part of a refresher. The context switch in the present invention or various embodiments enables the author or administrator to make the learning and study environment reflect as closely as possible the actual testing or application environment. In practice, if the learner will need to recall the information without the help of a visual aid, the learning system can be adapted to present the questions to the learner without the visual aids at later stages of the learning process. If some core knowledge were required to begin the mastery process, the images might be used at an early stage of the learning process. The principle here is to wean the learner off of the images or other supporting but non-critical assessment and/or learning materials over some time period. In a separate yet related configuration of the context switch, the author can determine what percentage of scenario-based learning is required in a particular ampObject or module.

Elaboration: This switch has various configuration options. For example, the elaboration switch allows the author to provide simultaneous assessment of both knowledge and certainty in a single response across multiple venues and formats. Elaboration may consist of an initial question, a foundational type question, a scenario-based question, or a simulation-based question. This switch requires simultaneous selection of the correct answer (recognition answer type) and the degree of confidence. In addition, the learner must contrast and compare the various answers before providing a response. It also provides a review of the explanation of both correct and incorrect answers. This may be provided by a text-based answer, a media-enhanced answer or a simulation-enhanced answer. Elaboration provides additional knowledge that supports the core knowledge and also provides simple repetition for the reinforcement of learning. This switch can also be configured to once (1×) correct (Proficiency) or twice (2×) correct (Mastery) levels of learning. In practice, the information being currently tested is associated with other information that the learner might already know or was already tested on. When thinking about something you already know, you can associate this bit of learning to elaborate and amplify the piece of information you are trying to learn. In the author role, the use of shadow questions as described above may be implemented in the elaboration switch as a deeper (elaborative) form of learning against a particular competency. The system also may provide enhanced support of differing simulation formats that provide the ability to incorporate testing answer keys into the simulation event. A more “app-like” user interface in the learning modules engages both the kinesthetic as well as cognitive and emotional domains of the learner. The addition of a kinesthetic component (e.g. dragging answers to the desired response box) further enhances long-term retention through higher order elaboration.

Spacing: A spacing switch in accordance with aspects of the present invention and various embodiments utilizes the manual chunking of content into smaller sized pieces that allow biological processes that support long term memory to take place (e.g. protein synthesis), as well as enhanced encoding and storage. This synaptic consolidation relies on a certain amount of rest between testing and allows the consolidation of memory to occur. The spacing switch can be configured in multiple ways in the various embodiments of the invention, such as setting the number of ampObjects per round of learning within a module, and/or the number of ampObjects per module.

Certainty: A certainty switch allows the simultaneous assessment of both knowledge and certainty in a single response. This type of assessment is important to a proper evaluation of a learner's knowledge profile and overall stage of learning. Simultaneous evaluation of both knowledge (cognitive domain) and certainty (emotional domain) enhances long-term retention through the creation of memory associations in the brain. The certainty switch in accordance with aspects of the present invention and various embodiments can be formatted with a configuration of once (1×) correct (proficient) or twice (2×) correct (mastery).

Attention: An attention switch in accordance with aspects of the present invention and various embodiments requires that the learner provide a judgment of certainty in his/her knowledge (i.e. both emotional and relational judgments are required of the learner). As a result, the learner's attention is heightened. Chunking can also be used to alter the degree of attention required of the learner. For example, chunking of the ampObjects (the number of ampObjects per module, and the number of ampObjects displayed per round of formative assessment and learning) focuses the learner's attention on the core competencies and associated learning required to achieve mastery in a particular subject. In addition, provision of salient and intriguing feedback at desired stages of learning and/or assessment ensures that the learner is fully engaged in the learning event (versus being distracted by activities not associated with the learning event).

Motivation: A motivation switch in accordance with aspects of the present invention and various embodiments enables a learner interface that provides clear directions as to the learner's progress within one or more of the rounds of learning within any given module, course or curriculum. The switch in the various embodiments can also display to the learner either qualitative (categorization) or quantitative (scoring) progress results to each learner.

Risk and Rewards: A risk/reward switch provides rewards according to a mastery-based reward schedule which triggers dopamine release and causes attention and curiosity in the learner. Risk is manifest because learners are penalized when a response is Confident & Incorrect or Partially Sure & Incorrect. The sense of risk can be heightened when a progress graphic is available to the user at all phases of learning.

### Registration

Aspects of the present invention and various embodiments include a built-in registration capability whereby user accounts can be added or deleted from the system, users can be placed in an ‘active’ or ‘inactive’ state, and users (via user accounts) can be assigned to various assessment and learning programs in the system. In the current embodiment of the invention, registration is managed in the Registration and Data Analytics application. In an earlier embodiment, registration was managed in the three-tier unified application system. Registration can also be managed in external systems (such as a Learning Management System or portal), and that registration information is communicated to the system through technical integration.

### Learning Management System Integration

Aspects of the present invention and various embodiments have the capability of operating as a stand-alone application or can be technically integrated with a third-party Learning Management Systems (“LMS”). Learners that have various assessment and learning assignments managed in the LMS can launch and participate in assessment and/or learning within the system with or without single sign-on capability. The technical integration is enabled through a variety of industry standard practices such as Aviation Industry CBT Committee (AICC) interoperability standards, http posts, web services, and other such standard technical integration methodologies.

### Avatar

In various embodiments of the system, an avatar with succinct text messages is displayed to provide guidance to the learner on an as-needed basis. The nature of the message, and when or where the avatar is displayed, is configurable by the administrator of the system. It is recommended that the avatar be used to provide salient guidance to the user. For example, the avatar can be used to provide guidance regarding how the switches (described above) impact the learning from the respect of the learner. In the present invention, the avatar is displayed only to the learner, not the author or other administrative roles in the system.

Structure of ampObject Libraries and Assignments

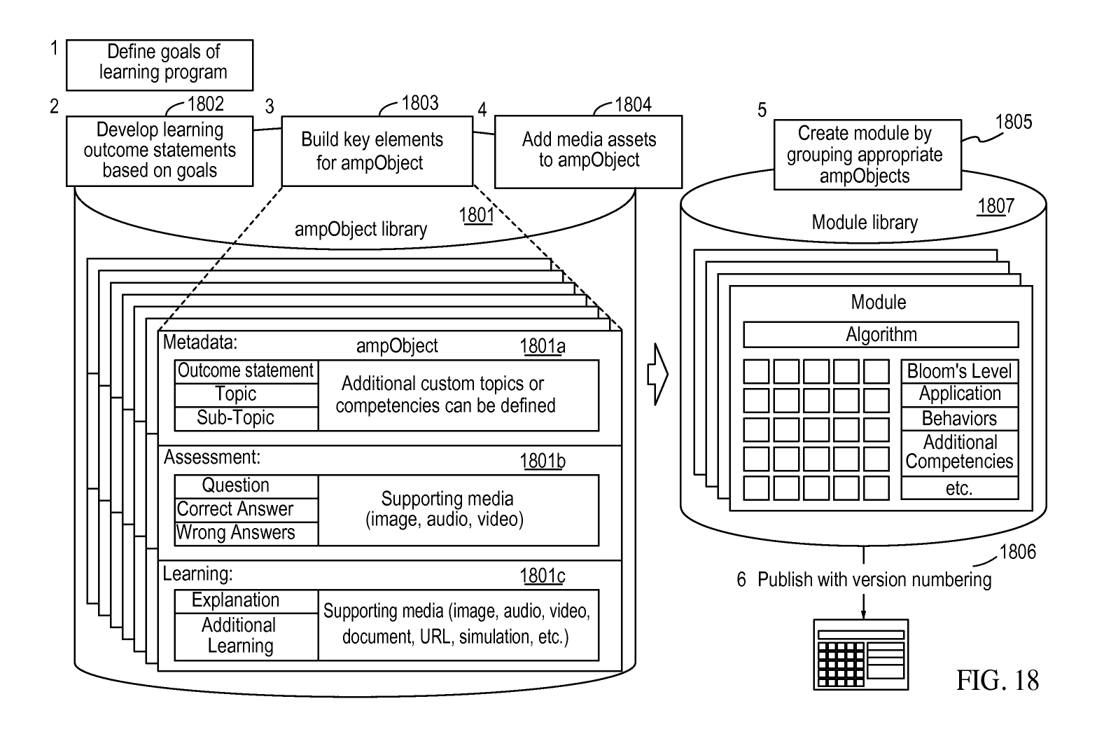

FIG. 18 illustrates the overall structure of an ampObject library constructed in accordance with aspects of the present invention. In one embodiment, an ampObject library 1800 comprises a metadata component 1801a, an assessment component 1801b and a learning component 1801c. The metadata component 1801a is divided into sections related to configurable items that the author desires to be associated with each ampObject, such as competency, topic and sub-topic. In addition to the metadata component, the assessment component is divided into sections related to an introduction, the question, a correct answer, and wrong answers. The learning component 1801c is further divided into an explanation section and an Additional Learning section.

Also included is a module library 1807 that contains the configuration options for the operative algorithms as well as information relating to a Bloom's level, the application, behaviors, and additional competencies. An administrator or author may utilize these structures in the following manner. First, an ampObject is created at 1802, key elements for the ampObject are built at 1803, and the content and media is assembled into an ampObject at 1804. Once the ampObject library 1801 is created, the module 1807 is created by determining the appropriate ampObjects to include in the module. After the module is created, the learning assignment is published.

### Service Oriented Architecture (SOA) and System Components and Roles:

Referring back for example to FIG. 3, at a high level, the system architecture 300 is a service-oriented architecture (SOA) that utilizes a multiple-tiered (“n-tiered) architecture coupled through each of the services. The system architecture 300 includes several distinct application components including among them one or more of the following: A System Administration application, a Content Management system (CMS) application, a Learning application, and a Registration and Data Analytics (RDA) application.

Content Management System Roles: CMS enables certain roles within the system, including content author, content manager, resource librarian, publisher, translator, reviewer and CMS administrator. The content author role provides the ability to create learning objects and maintain them over time. The resource librarian role provides the ability to manage a library of resources that can be used to create content for the learner. The translator role provides the ability to translate content into another language and otherwise adjust the system for the locale where the system is being administered. The content manager role provides the ability to manage a staff of authors, resource librarians and translators. The publisher role provides the ability to manage the organizational structure of the curriculum, and to decide when to publish works and when to prepare new versions of existing works. The reviewer role provides the ability to provide feedback on content prior to publication. The CMS administrator role provides the ability to configure the knowledge assessment system for use within any particular organization.

Content Author's Goals: The content author is adapted to provide several functions including one or more of the following:
a. Creating learning objects (ampObjects) that are compelling and informative,
b. Designating the metadata/classifications that a learning object supports,
c. Making a learning object available to be used by others on my team—e.g., incorporated into a module,
d. Designating a learning object as “frozen” so that a particular authoring team knows it is in final form and no more changes are anticipated,
e. “Tag” learning objects so that a user can easily find them later,
f. See what a learning object might look like to the learner,
g. See who created a learning object and who worked on it most recently,
h. See where a learning object is being used,
i. Create a new version of a frozen or published learning object when it is time to begin work on updates to existing content,
j. Designate a learning object—or a specific version of a learning object—that is obsolete as “retired” so that it is no longer available for (new) use,
k. See the version history of a learning object,
l. Import external content into the system,
m. Export content in a format to be used outside of the system,
n. Combine learning objects into modules (assessment and/or learning modules),
o. Combine modules into higher-order curriculum structures (e.g., courses, programs, lessons, etc.).

Content Resource Librarian's Goals: The content resource librarian is adapted to provide several functions including one or more of the following:
a. Upload existing resources into the resource library for use by authors on any given team who are creating learning objects or curricula,
b. Upload or create new resources,
c. Update existing resources when needed,
d. Create a new version of a resource that has already been published,
e. See where a resource is being used,
f. Import external content into the system,
g. “Tag” resources so that a system user can easily find them later,
h. See who created a resource (and when) and who worked on it most recently (and when).

Content Translator's Goals: The content translator is adapted to provide several functions including one or more of the following:
a. Create translations (and in some cases, localizations) of the learning objects in a work that is in progress or has already been published,
b. Update existing translations (localizations) when a work is updated,
c. See what translations exist for learning objects and where translations still need to be performed,
d. Validate that the system adequately supports the required language, and if not, provide input to the learning application and portal.

As used above, “Translation” is the expression of existing content in another language. “Localization” is fine-tuning of a translation for a specific geographic (or ethnic) area. By way of example, English is a language; US and UK are locales, where there are some differences in English usage in these two locales (spelling, word choice, etc.).

Content Manager's Goals: The content manager is adapted to provide several functions including one or more of the following:
a. Organize content (learning objects and resources) in a manner that is appropriate to my organization and team structure,
b. Assign roles to a team member,
c. Grant access permissions to content (read/write/none) to members of a team (and potentially other people as well),
d. Manage a set of classifications that a particular content will be created to support,
e. Direct the work of the authors, resource librarians, reviewers and translators,
f. Ensure that the review process is being carried out correctly prior to publication,
g. Freeze content before it is published,
h. Manage a set of styles used in the creation and layout of content,
i. Post a module (or a collection of content) in a place where it can be reviewed for comment by internal and external users,
j. Set scoring and presentation options for a module.

Content Publisher's Goals: The content publisher is adapted to provide several functions including one or more of the following:
a. Create a curriculum organizational structure that reflects the ways that works are managed and published,
b. Create modules that pull together the content that has been created,
c. Identify the classifications (or learning outcomes) that each module is designed to support,
d. See where existing content and elements of the curriculum are being used,
e. Publish a curriculum in multiple translations,
f. Identify opportunities for reuse of existing content and elements of the curriculum,
g. Decide when a work is ready to be published (including completed translations),
h. Decide when to begin work on a new version of a published work,
i. Decide when to publish a translation (localization) of a published work.

Content Reviewer's Goals: The content reviewer is adapted to provide several functions including one or more of the following:
a. Review content for completeness, grammar, formatting and functionality. In this context, functionality means to ensure that links are working and launching correctly as well as images, videos and audios are playing or displaying correctly and are appropriate as used,
b. Provide feedback and suggested changes to content,
c. View comments from other reviewers,
d. Let others know when his/her review is complete.

CMS Administrator Goals: The CMS administrator is adapted to provide several functions including one or more of the following:

a. Administer sub-accounts (for administrators of top level accounts only),

b. Administer user roles, access and permissions (along with manager).

Learning System Roles: The learning system or application 950 generally provides the ability to complete assignments and master content to a particular learner.

Learner's Goals: The learner is adapted to provide several functions including one or more of the following:
a. Master information from a course,
b. Improve confidence in knowledge and skills,
c. Have a fun and engaging experience while learning,
d. Have the ability to learn as efficiently and effectively as possible,
e. Share information with a social network (twitter, Facebook, Chats, etc.),
f. See assignments and status, due dates, etc.,
g. See pre-requirements and post-requirements (e.g. additional learning, documents, links) associated with an assignment,
h. Initiate, continue or complete a learning assignment,
i. Review a completed learning assignment,
j. Refresh knowledge from a previous learning assignment,
k. Self-register and go directly into the Learning application,
l. Download and print certificates for assignments that have been completed,
m. Have a learning experience in an environment that is comfortable, convenient and familiar,
n. Know where I am in his learning progress—e.g., the total number of questions in a module, the number of questions remaining in a particular question set, elapsed time, mastery level, score,
o. Experience learning in the learner's native language.

Registration and Data Analytics (RDA) Roles: RDA 308 enables certain roles within the system, including that of a registrar, an instructor, an analyst and an RDA administrator. The role of the registrar is to administer learner accounts and learner assignments in the system. The goal of the instructor is to view information regarding all students, a subset of students or a student's results. The goal of the analyst is to understand learner performance and activity for a particular organization or individual. The goal of the RDA administrator is to configure the RDA for use within any particular organization.

Registrar's Goals: The registrar is adapted to provide several functions including one or more of the following:
a. Administer learners in the system, including creating new learners and deactivating existing learners,
b. Register learners for one or more curriculum element (e.g. module, book, etc.),
c. Modify existing registrations, including canceling or replacing existing registrations,
d. Upload a file of information regarding learners and their registrations, including new registrations and updates to existing registrations,
e. View the status of all registrations for a learner,
f. View the status of all learners for an assignment or group of assignments,
g. View a particular activity, e.g. sessions, completions, registrations, etc.,
h. Send emails or messages to learners,
i. View a list of emails or other messages that have been sent to learners,
j. Print learner's certificates.

Instructor's Goals: The instructor is adapted to provide several functions including one or more of the following:
a. See information regarding all students, a subset of students or a student's results including the ability to find areas of strengths and/or weakness,
b. Adapt a lesson plan to address a student's areas of weaknesses.

Analyst's Goals: The analyst is adapted to provide several functions including one or more of the following:
a. View information regarding the status of registrations and assignments,
b. View information regarding activity on the system, such as new assignments, completed assignments, or user sessions,
c. View information regarding learners' performance at a detailed level, e.g. areas of classifications, number of presentations to complete a question, length of time to complete the module,
d. Offer the option to explore information through online interaction (drill-down),
e. Offer the option to capture information so an offline analysis (reports, export, data downloads) can be completed.

RDA Administrator's Goals—The RDA administrator is adapted to provide several functions including one or more of the following:

a. Designate demographic data to be collected during registration,

b. Customize a self registration page,

c. Assign or un-assign RDA roles to specific users.

Addition System Goals and Roles: The knowledge management system may also include one or more of the following functions and capabilities:
a. Increase the speed of knowledge acquisition,
b. Provide enterprise level content management capabilities,
c. Provide enterprise-level scalability of the learning application,
d. Integrate with external learning management systems,
e. Import content from external content management systems,
f. Enable learners to use the system without providing personally identifiable information,
g. Track the use of published content by account or organization,
h. Associate each learner with an account or organization,
i. Associate each account or organization with an accounting code,
j. Track learner activity by account or organization, e.g. learners, active learners, new registrations, completions and hours of usage,
k. Integrate with third-party software,
l. Track and report data use by all roles; manager, publisher, admin, etc.,
m. Track content usage at the learning object level,
n. Create internal reports to provide proactive support of all customer types.

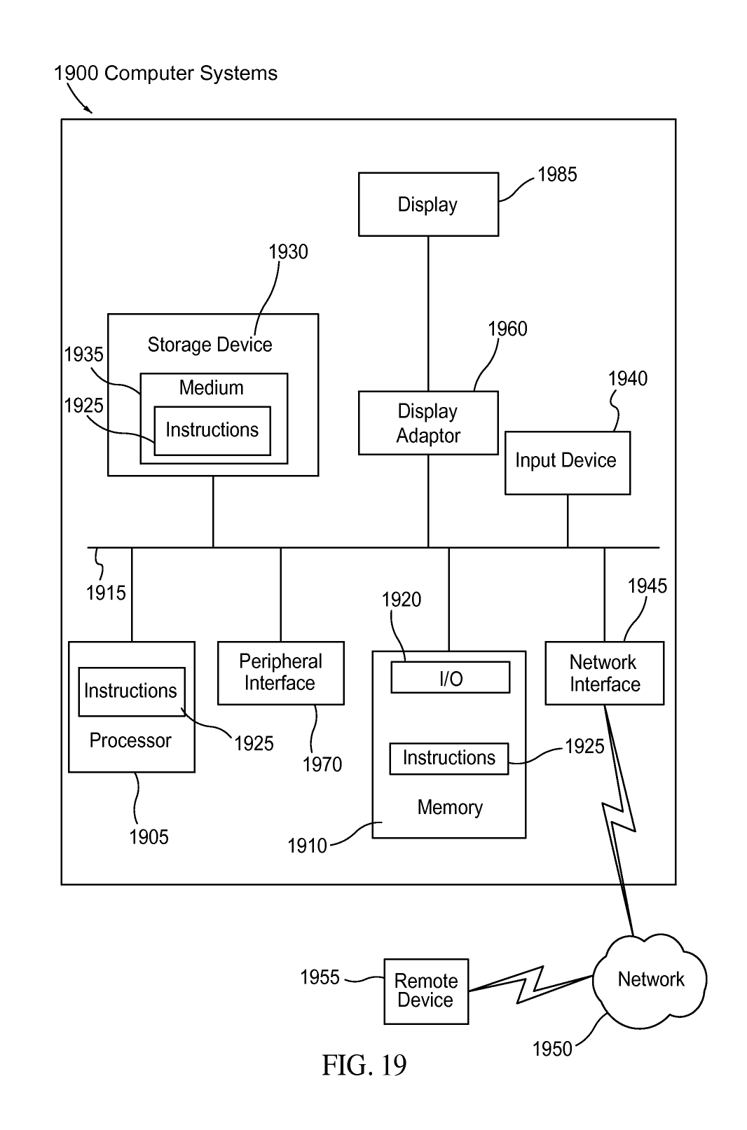

FIG. 19 illustrates a diagrammatic representation of one embodiment of a machine in the form of a computer system 1900 within which a set of instructions for causing a device to perform any one or more of the aspects and/or methodologies of the present disclosure may be executed. Computer system 1900 includes a processor 1905 and a memory 1910 that communicate with each other, and with other components, via a bus 1915. Bus 1915 may include any of several types of bus structures including, but not limited to, a memory bus, a memory controller, a peripheral bus, a local bus, and any combinations thereof, using any of a variety of bus architectures.

Memory 1910 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 1920 (BIOS), including basic routines that help to transfer information between elements within computer system 1900, such as during start-up, may be stored in memory 1910. Memory 1910 may also include (e.g., stored on one or more machine-readable media) instructions (e.g., software) 1925 embodying any one or more of the aspects and/or methodologies of the present disclosure. In another example, memory 1910 may further include any number of program modules including, but not limited to, an operating system, one or more application programs, other program modules, program data, and any combinations thereof.

Computer system 1900 may also include a storage device 1930. Examples of a storage device (e.g., storage device 1930) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 1930 may be connected to bus 1915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1930 may be removably interfaced with computer system 1900 (e.g., via an external port connector (not shown)). Particularly, storage device 1930 and an associated machine-readable medium 1935 may provide nonvolatile and/or volatile storage of machine-readable instructions, data structures, program modules, and/or other data for computer system 1900. In one example, software 1925 may reside, completely or partially, within machine-readable medium 935. In another example, software 1925 may reside, completely or partially, within processor 1905. Computer system 1900 may also include an input device 1940. In one example, a user of computer system 1900 may enter commands and/or other information into computer system 1900 via input device 1940. Examples of an input device 1940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch-screen, and any combinations thereof. Input device 1940 may be interfaced to bus 1915 via any of a variety of interfaces (not shown) including, but not limited to, a serial interface, a parallel interface, a game port, a USB interface, a FIREWIRE interface, a direct interface to bus 1915, and any combinations thereof.

A user may also input commands and/or other information to computer system 1900 via storage device 1930 (e.g., a removable disk drive, a flash drive, etc.) and/or a network interface device 1945. A network interface device, such as network interface device 1945 may be utilized for connecting computer system 1900 to one or more of a variety of networks, such as network 1950, and one or more remote devices 1955 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 1950, may employ a wired and/or a wireless mode of communication. In general, any network topology may be used. Information (e.g., data, software 1925, etc.) may be communicated to and/or from computer system 1900 via network interface device 1945.

Computer system 1900 may further include a video display adapter 1960 for communicating a displayable image to a display device, such as display device 1965. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 1900 may include one or more other peripheral output devices including, but not limited to, an audio speaker, a printer, and any combinations thereof. Such peripheral output devices may be connected to bus 1915 via a peripheral interface 1970. Examples of a peripheral interface include, but are not limited to, a serial port, a USB connection, a FIREWIRE connection, a parallel connection, and any combinations thereof. In one example an audio device may provide audio related to data of computer system 1900 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 1965. Accordingly, a digitizer may be integrated with display device 1965, or may exist as a separate device overlaying or otherwise appended to display device 1965. Display devices may also be embodied in the form of tablet devices with or without touch-screen capability.

### Industry Applications

### 1. Certification

The confidence-based assessment can be used as a confidence-based certification instrument, both as a pre-test practice assessment, and as a learning instrument. As a pre-test assessment, the confidence-based certification process would not provide any remediation, but only provide a score and/or knowledge profile. The confidence-based assessment would indicate whether the individual had any confidently held misinformation in any of the certification material being presented. This would also provide, to a certification body, the option of prohibiting certification where misinformation exists within a given subject area. Since the CBA method is more precise then current one-dimensional testing, confidence-based certification increases the reliability of certification testing and the validity of certification awards.

In the instance where the system is used as a learning instrument, the learner can be provided the full breadth of formative assessment and learning manifest in the system to assist the learner in identifying specific skill gaps, and filling those gaps remedially.

### 2. Scenario-Based Learning

The confidence-based assessment can apply to adaptive learning approaches in which one answer generates two metrics with regard to confidence and knowledge. In adaptive learning, the use of video or scenarios to describe a situation helps the individual work through a decision making process that supports his/her learning and understanding. In these scenario-based learning models, individuals can repeat the process a number of times to develop familiarity with how they would handle a given situation. For scenarios or simulations, CBA and CBL adds a new dimension by determining how confident individuals are in their decision process. The use of the confidence-based assessment using a scenario-based learning approach enables individuals to identify where they are uninformed and have doubts in their performance and behavior. Repeating scenario-based learning until individuals become fully confident increases the likelihood that the individuals will act rapidly and consistently as a result of their training. CBA and CBL are also ‘adaptive’ in that each user interacts with the assessment and learning based on his her own learning aptitude and prior knowledge, and the learning will therefore be highly personalized to each user.

### 3. Survey

The confidence-based assessment can be applied as a confidence-based survey instrument, which incorporates the choice of three possible answers, in which individuals indicate their confidence in and opinion on a topic. As before, individuals select an answer response from seven options to determine their confidence and understanding in a given topic or their understanding of a particular point of view. The question format would be related to attributes or comparative analysis with a product or service area in which both understanding and confidence information is solicited. For example, a marketing firm might ask, “Which of the following is the best location to display a new potato chip product? A) at the checkout; B) with other snack products; C) at the end of an aisle.” The marketer is not only interested in the consumer's choice, but the consumer's confidence or doubt in the choice. Adding the confidence dimension increases a person's engagement in answering survey questions and gives the marketer richer and more precise survey results.

Further aspects in accordance with the present invention provide learning support where resources for learning are allocated based on the quantifiable needs of the learner as reflected in a knowledge assessment profile, or by other performance measures as presented herein. Thus, aspects of the present invention provide a means for the allocation of learning resources according to the extent of true knowledge possessed by the learner. In contrast to conventional training where a learner is generally required to repeat an entire course when he or she has failed, aspects of the present invention disclosed herein facilitate the allocation of learning resources such as learning materials, instructor and studying time by directing the need of learning, retraining, and reeducation to those substantive areas where the subject is misinformed or uninformed.

Other aspects of the invention effected by the system offers or presents a “Personal Training Plan” page to the user. The page displays the queries, sorted and grouped according to various knowledge regions. Each of the grouped queries is hyper-linked to the correct answer and other pertinent substantive information and/or learning materials on which the learner is queried. Optionally, the questions can also be hyper-linked to online informational references or off-site facilities. Instead of wasting time reviewing all materials covered by the test query, a learner or user may only have to concentrate on the material pertaining to those areas that require attention or reeducation. Critical information errors can be readily identified and avoided by focusing on areas of misinformation and partial information.

To effect such a function, the assessment profile is mapped or correlated to the informational database and/or substantive learning materials, which is stored in the system or at off-system facilities such as resources within an organization's local area network (LAN) or in the World Wide Web. The links are presented to the learner for review and/or reeducation.

In addition, the present invention further provides automated cross-referencing of the test queries to the relevant material or matter of interest on which the test queries are formulated. This ability effectively and efficiently facilitates the deployment of training and learning resources to those areas that truly require additional training or reeducation.

Further, with the present invention, any progress associated with retraining and/or reeducation can be readily measured. Following a retraining and/or reeducation event, (based on the prior performance results) a learner could be retested with portions or all of test queries, from which a second knowledge profile can be developed.

In all the foregoing applications, the present method gives more accurate measurement of knowledge and information. Individuals learn that guessing is penalized, and that it is better to admit doubts and ignorance than to feign confidence. They shift their focus from test-taking strategies and trying to inflate scores toward honest self-assessment of their actual knowledge and confidence. This gives subjects as well as organizations rich feedback as to the areas and degrees of mistakes, unknowns, doubts and mastery. Having now fully set forth the preferred embodiments and certain modifications of the concept underlying the present invention, various other embodiments as well as certain variations and modifications of the embodiments herein shown and described will obviously occur to those skilled in the art upon becoming familiar with the underlying concept. It is to be understood, therefore, that the invention may be practiced otherwise than as specifically set forth herein.

What is claimed is:

1. A services-oriented system for knowledge assessment and learning, comprising:
a display device for displaying to a learner at a client terminal a plurality of multiple-choice questions and two-dimensional answers;
an administration server adapted to administer one or more users of the system;
a content management system server adapted to provide an interface for the one or more users to create and maintain a library of learning resources;
a learning system server comprising a database of learning materials, wherein the plurality of multiple-choice questions and two-dimensional answers are stored in the database for selected delivery to the client terminal;
a registration and data analytics server adapted to create and maintain registration information about the learners;
the system for knowledge assessment performing a method of,
transmitting to the display device the plurality of multiple-choice questions and two-dimensional answers thereto, the answers including a plurality of full-confidence answers consisting of single-choice answers, a plurality of partial-confidence answers consisting of one or more sets of multiple single-choice answers, and an unsure answer;
administering an assessment by presenting to the learner via the display device the plurality of multiple-choice questions and the two-dimensional answers thereto, and receiving via the display device the learner's selected answer to the multiple-choice questions by which the learner indicates both their substantive answer and the level of confidence category of their answer; and
scoring the assessment by assigning a knowledge state designation to at least one of the answers by the learner.

2. The system of claim 1, wherein the administration server includes an account database and is adapted to provide account service functionality.

3. The system of claim 1, wherein the content management system server includes an authoring database and is adapted to provide authoring and publication service functionality.

4. The system of claim 1, wherein the learning system server includes a learning database and is adapted to provide learning service functionality.

5. The system of claim 1, wherein the registration and data analytics server includes registration and data warehouse database and is adapted to provide registration and reporting service functionality.

6. The system of claim 1, wherein scoring the assessment by assigning a knowledge state designation to at least one of the answers by the learner comprises assigning the following knowledge state designations:
a proficient or mastery knowledge state in response to a confident and correct answer by the learner;
an informed knowledge state in response to a doubt and correct answer by the learner;
an unsure knowledge state in response to a not sure answer by the learner;
an uninformed knowledge state in response to a doubt and incorrect answer by the learner; and
a misinformed knowledge state in response to a confident and incorrect answer by the learner.

7. The system of claim 1, further comprising a migration database server for importing content from an external source.

8. The system of claim 1, wherein administering the assessment further comprises including one or more cognitive switches to enhance learning and memory.

9. The system of claim 8 wherein the switches are selected from the group consisting of Repetition, priming, progress, feedback, context, elaboration, spacing, certainty, attention, motivation, and risk/reward,

10. The system of claim 1 wherein administering the assessment further comprises administering a learning module that identifies skill gaps of the learner.

11. A service-oriented computer structure comprising a multi-tiered services structure adapted to perform a method of knowledge assessment, the method comprising:
creating, through an interface to a content management server, a knowledge assessment application;
providing the knowledge assessment application to a learner through a learning server;
enabling the learner to access the knowledge assessment through a registration and data analytics server;
displaying to the learner at a display device a plurality of multiple-choice questions and two-dimensional answers stored at the content management server;
transmitting via the communications network to the display device the plurality of multiple-choice questions and two-dimensional answers, wherein the answers include a plurality of full-confidence answers consisting of single-choice answers, a plurality of partial-confidence answers consisting of one or more sets of multiple single-choice answers, and an unsure answer;
administering an assessment comprising presenting to the learner via the display device the plurality of multiple-choice questions and the two-dimensional answers, and receiving via the display device the learner's selected answers to the multiple-choice questions by which the learner indicates both their substantive answer and the level of confidence category of their answer; and
scoring the assessment.

12. The service-oriented computer structure of claim 11, wherein scoring the assessment comprises assigning the following designations:
a proficient or mastery knowledge state in response to a confident and correct answer by the learner;
an informed knowledge state in response to a doubt and correct answer by the learner;
an unsure knowledge state in response to a not sure answer by the learner;
an uninformed knowledge state in response to a doubt and incorrect answer by the learner; and
a misinformed knowledge state in response to a confident and incorrect answer by the learner.

13. The service-oriented computer structure of claim 11, further comprising a content management system server and a data analytics application.

14. The service-oriented computer structure of claim 11, wherein creating, through an interface to a content management server a knowledge assessment application comprises:
creating an ampObject;
building elements for the ampObject;
assembling content and media into the ampObject; and
assembling a learning module from a plurality of ampObjects.

15. The service-oriented computer structure of claim 11 wherein the ampObject comprises metadata corresponding to the ampObject, assessment data corresponding to the ampObject and learning data corresponding to the ampObject.

16. The service-oriented computer structure of claim 11 wherein the metadata includes topic and sub-topic definitions.

17. The service-oriented computer structure of claim 11 wherein the assessment data includes associated learning data selected from video, audio and image data.

18. The service-oriented computer structure of claim 11 wherein the learning data includes associated learning data selected from video, audio and image data.

19. The service-oriented computer structure of claim 11, wherein administering the assessment further comprises including one or more cognitive switches to enhance learning and memory.

20. The service-oriented computer structure of claim 11 wherein the switches are selected from the group consisting of Repetition, priming, progress, feedback, context, elaboration, spacing, certainty, attention, motivation, and risk/reward,

21. The service-oriented computer structure of claim 11 wherein administering the assessment further comprises administering a learning module that identifies skill gaps of the learner.

22. A computer database system structure configured to deliver to a learner at a client terminal a plurality of multiple-choice questions and two-dimensional answers, comprising:
a content management system server adapted to provide an interface for the one or more users to create and maintain a library of learning resources;
a learning system server for storing a database of learning materials, wherein the plurality of multiple-choice questions and two-dimensional answers are stored in the database for selected delivery to the client terminal;
the database of learning materials comprising a module library and a learning object library, the learning object library comprising a plurality of learning objects, each of the plurality of learning objects comprising,
metadata corresponding to the learning object,
assessment data corresponding to the learning object, and
learning data corresponding to the learning object.

23. The computer database structure of claim 22, wherein the metadata component comprises at least one configurable item related to the learning object.

24. The computer database structure of claim 23, wherein the configurable item corresponds to a competency item.

25. The computer database structure of claim 23, wherein the configurable item corresponds to a topic item.

26. The computer database structure of claim 22, wherein the module library comprises structure for storing an adaptive learning algorithm for delivering and scoring a knowledge assessment by assigning a knowledge state designation to at least one of the answers by the learner, the algorithm assigning at least one of the following knowledge state designations:
a proficient or mastery knowledge state in response to a confident and correct answer by the learner;
an informed knowledge state in response to a doubt and correct answer by the learner;
an unsure knowledge state in response to a not sure answer by the learner;
an uninformed knowledge state in response to a doubt and incorrect answer by the learner; and
a misinformed knowledge state in response to a confident and incorrect answer by the learner.
